SEQUENCE LISTING (19 sequences)

SEQ ID NO: 1 - DNA, 551 bp, Artificial
  mutated DAN1 promoter
agctcaattcacgctggattcggcgatccgttttcttcaatcctcacgtgctttcttcgtttgagtgcaaaagttcatatgatgctatctcccgcttaccttattagtcgaaaatggggagaatttcctattttatctgtcgtttagcacatatggccaggaagatacataaggtttcgccgaacgacggggtcaattcgtcctttttgtacacatcgtttaatttatgaggaaaaattgatgaatgtatcctccgtagacgctcctctgaaaagtttcatgttccctgcgcgttcctttgataggcaataaaacaatacaacgcgtgcctttgaaaatgccgagatctatacgaggcctctaacaaaacatcgttcaggaacagagaatactagaaatgcaaaagggtccctgggtactcattgaatagagatgattgaaaatactgcgtataaaatagcacgactaagtgatactatttttatgtcgacacggtactatttcttctttttcagataaaagtgtagcatactaaatatataccccaagta

SEQ ID NO: 2 - DNA, 551 bp, Artificial
  mutated DAN1 promoter
agctcaattcacgctggattaggcggtccgttttcttcaatcctcacgtgctttcttcgtttgagtgcaaaagttcatatgatgctatctcccgcttatcttattagtcgaaaatggggagaatttcctattttatctgtcgtttagcacatatggccaggaaaatacataaggtttcgccgaacggcggggtcaattcgtcctttctgtacacatcgtttaattcatgagggaaaattgatgaatgtatcctccgtagacgctcctctgaaaagtttcatgtttcctgcgcgttcctttgataggcaataaaacaatacgacgcgtgcctttgaaaatgccaggatctatacgaggcctctaacaaaacatcgttcaggaacagagaatgctagaaatgcaagagggtccctgggtactcattgaatagaaatgattgaaaatgctgcgtataaaatagcacgactaaatgatactatttttatgtcgacacggtactatttcttctttttcagataaaagtgtagcatactaaatatataccccaagta

SEQ ID NO: 3 - DNA, 551 bp, Artificial
  mutated DAN1 promoter
agctcaattcacgctggactcggcggtccgttttcttcaatcctcacgtgctttcttcgtttgagtgcaaaagttcatatgatgctatctcccgcttatcttattagtcgaaaatggggagaatttcctattttatctgtcgtttagcacatatggccaggaaagtacatagggtttcgccgaacgacggggtcaattcgtcctttttgtacacatcgtttaatttacgaggaaaaattgatgaatgtatcctccgtagacgctcctctgaaaagtttcacgtttcctgcgcgttcctttgataggcaataagacaatacaacgcgtgcccttgaaactgccaagatctatacgaggcctctaacaaaacatcgttcaggaacagagaatgctagaaatgcaaaagggtccctgggtactcattgaatagaaatgattgaaaatactgcgtataaaatagcacgactaaatgatactatttttatgtcgacacggtactatttcttctttttcagatcaaagtgtagcatactaaatatataccccaagta

SEQ ID NO: 4 - DNA, 551 bp, Artificial
  mutatted DAN1 promoter
agctcaattcacgctggattcggcgattcgttttcctcaatcctcacgtgctttcttcgtttgagtgcaaaagtccatatgatgccatctcccgcttatcttattagtcgaaaatggggagaatttcctattttacctgtcgtttagcacatatggccaggaagatacataaggtttcgccgaacgacggggtcaattcgtcctttttgtacacatcgtttaatttatgagggaaacttgatgaatgtatcctccgtagacgctcctctgaaaagtttcatgtttcctgcgcgttcctttgataggcgataaaacaatacaacgcgtgcctttgaagatgccaaggtctatacgaggcctctaacaagacatcgttcaggaacagagaacgctagaaatgcaaaagggtccctgggtactcattgagtagaaatgattaaaaatactgcgtataaaatagcacgactaaatgatactatctttatgtcgacacggtactatttcttctttttcagataaaagtgtagcatactaaatatataccccaagta

SEQ ID NO: 5 - DNA, 551 bp, Artificial
  mutated DAN1 promoter
agctcaattcacgctggattcggcgatccgttttcttcaatcctcacgtgctttcttcgtttaagcgcaaaagttcacatgatgctatctcccgcttatcttattagtcgaaaatggggagaatttcctattttatctgtcgtttagcacatatggccaggaaaatacataaggtttcgccgaacgacggggtcaattcgtcctttttgtacacatcgtttaatttatgaggaaaaattgatgaatgtatcctccgtagacgctcctctgaaaagtttcgtgtttcctgcgcgttcctttgataggtaacaaaacaatacaacgcgtgcctttgaaaatgccaagatctatacgaggcctctaacaaaacatcgttcaggaacagggaatgctagagatgcaaaagggtccctgggtactcgttgaatagaaatgattgaaaatactgcgtataaaatagcacgactaaatgatactatttttatgtcgacgcggtactatttcttctttttcagataaaagtgtagcatactaaatatataccccaagta

SEQ ID NO: 6 - DNA, 551 bp, Artificial
  mutated DAN1 promoter
agctcaattcacgctggattcggcgatccgttttcttcaatcctcacgtgctctcttcgtttgagtgcaaaagctcatatgatgctatctcccgcttatcttattagtcgaaaatggggaggatttcctattttgtctgtcgtttagcacatatggccaggaaaatacataaggtttcgccgaacgacggggtcaatgcgtcctctctgtacacatcgtttaatttatgaggaaaaattgatgaatgtatcctccgtaggcgctcctctgaaaagtttcatgtttcctgcgcgttcctttgataggcaataaaacaatacaacgcgtgcctctgaaaatgccaggatctatacgaggcctctaacaaaacatcgttcaggaacagagaatgttagaaatgcaaaagggtccctgggtactcattgaatggaaacgattgaaaatactgcgtataaaatagcacgactaaatgataccatttttatgtcgacacggtactatttcttctttctcagataaaagtgtagcatactaaatatataccccaagta

SEQ ID NO: 7 - DNA, 551 bp, Artificial
  mutated DAN1 promoter
agctcaattcacgctgggttcggcgatccgttttcttcaatcctcacgtgctttcttcgtttgagtgcaaaagttcatatgatgctatctcccgcttatcttattagtcgaaaatggggagaatttcctattttatctgtcgtttagcgcatatggccaggaaaatacataaggtctcgccgaacgacggggtcaattcgtcctttttgtacacatcgtttaatttatgaggagaaattggtgaatgtatcctccgtagacgctcctctgaaaagtttcatgtttcctgcgcgttcctttgataggcaataaaacaatacaacgcgtgcctttgaaaatgccaagatctatacgaggcctctaacaaaacattgttcaggaacagagaatgctaggaatgcaaaagggtccctgggtactcattgaatagaaatgattgaaaatactgcgtataaaatagcacgaccacatgatactatttttatgtcgacgcggtactatttcttccttttcagataaaagtgtagcatactaaatatataccccaagta

SEQ ID NO: 8 - DNA, 551 bp, Artificial
  mutated DAN1 promoter
agctcagttcacgctggattcggcgatccgttttcttcaatcctcacgtgctttcctcgcttgagtgcaaaagttcatatgatgctatctcccgcttatcttattagtcgaaaatggggagaatttcctattttatctgtcgtttagcacatatggccagggaaatacatgaggtttcgccgaacgacggggtcagttcgtcctttttgtgcacaccgtttaatttatgaggagaagttgatgaatgtatcctccgtagacgctcctccgaaaggtttcatgtttcctgcgcgtttctttgacaggcaataaaacaatacagcgcgcgcctttgaaaatgccaagatctatacgaggcctctaacgaaacatcgcccagggacggagaatgctagaaatgcgaaagggtccctgggtactcattgaacagaaatgattgaaaatactgcgtataaaatagcacgactaaatgatactatttttatgtcggcacggtactatttcttctttttcagataaaagtgtagcatactaaatatataccccaagta

SEQ ID NO: 9 - DNA, 551 bp, Artificial
  mutated DAN1 promoter
agctcaattcacgctggattcggcgatccgttttcttcaatcctcacgtgctttcttcgtttgagtgcaaaagttcatatgatgctatctcccgcttatcttattagtcgaaaatggggagaatttcctattttatctgtcgtttagcacatatggccaggaaaatacataaggtttcgccgaacgacggggtcaattcgtcctttttgtacacatcgtttaatttatgaggaaaaattgatgaatgtatcctccgtagacgctcctctgaaaagtctcatgtttcctgcgcgttcctttgataggcaataagacaatacaacgcgtgcctttgaaaatgccaagatctatacgaggcctctaacaaaacatcgttcaggaacagagaatgctagaaatgcaaaagggtccctgggtactcattgaatagagatgattgaaaatactgcgtataaaatagcacgactaagtgatactatttttatgtcgacacggtactatttcttctttttccgataaaagtgtagtatactaaatatataccccaagta

SEQ ID NO: 10 - DNA, 551 bp, Artificial
  mutated DAN1 promoter
agcccaattcacgccggattcagcgatccgttttcttcagtcctcacgtgctttcttcgtttgagtgcaaaagttcatatgatgctatctcccgcttatcttattagtcgaaaatggggagaatttcctatcttatctgtcgtttagcacatgtggccaggaaaatacataaggtttcgccgaacgacggggtcaattcgccctttttgtacacatcgtttaatttatgaggaaaaattgatgaatgtatcctccgtagacgctcctctgaaaagtttcatgtttcctgcgcgttcctctgataggcaataaaacaatacaacgcgtgcctttgaaaatgccaagatctatacgaggcctctaacaaaacatcgttcaggaacagagaatgctagaaatgcaaaagggtccctgggtactcattgaatagaaatgattgaaaatactgcgtataaaatagcacgactaaatgataccatttttatgtcgacacggtactatttcttctttttcagataaaagtgtagcatactaaatatataccccaagta

SEQ ID NO: 11 - DNA, 551 bp, Saccharomyces cerevisiae
agctcaattcacgctggattcggcgatccgttttcttcaatcctcacgtgctttcttcgtttgagtgcaaaagttcatatgatgctatctcccgcttatcttattagtcgaaaatggggagaatttcctattttatctgtcgtttagcacatatggccaggaaaatacataaggtttcgccgaacgacggggtcaattcgtcctttttgtacacatcgtttaatttatgaggaaaaattgatgaatgtatcctccgtagacgctcctctgaaaagtttcatgtttcctgcgcgttcctttgataggcaataaaacaatacaacgcgtgcctttgaaaatgccaagatctatacgaggcctctaacaaaacatcgttcaggaacagagaatgctagaaatgcaaaagggtccctgggtactcattgaatagaaatgattgaaaatactgcgtataaaatagcacgactaaatgatactatttttatgtcgacacggtactatttcttctttttcagataaaagtgtagcatactaaatatataccccaagta

SEQ ID NO: 12 - DNA, 24 bp, Saccharomyces cerevisiae
gttaaaaattgttgagctcaattc

SEQ ID NO: 13 - DNA, 35 bp, Saccharomyces cerevisiae
cgagttctagatacttggggtatatatttagtatg

SEQ ID NO: 14 - DNA, 38 bp, Artificial
  p416-TEF-yECtrine primer
cgagttctagaaaaatgtctaaaggtgaagaattattc

SEQ ID NO: 15 - DNA, 35 bp, Artificial
  p416-TEF-yECtrine primer
tagcgatcgatttatttgtacaattcatccatacc

SEQ ID NO: 16 - DNA, 47 bp, Artificial
  p416-TEF-yECtrine primer
attgggacaacaccagtgaataattcttcacctttagacatttttct

SEQ ID NO: 17 - DNA, 48 bp, Artificial
  p416-TEF-yECtrine primer
acgccaagcgcgcaattaaccctcactaaagggaacaaaagctggagc

SEQ ID NO: 18 - DNA, 22 bp, Saccharomyces cerevisiae
atggctgacaaacaaaagaatg

SEQ ID NO: 19 - DNA, 22 bp, Saccharomyces cerevisiae
cagattgataggataagtaatg

(19) United States
(12) Patent Application Publication
(10) Pub. No.: US 2007/0178505 A1
(43) Pub. Date: Aug. 2, 2007

(54) Promoter engineering and genetic control

(76) Inventors: Curt Fischer, Cambridge, MA (US); Gregory Stephanopoulos, Winchester, MA (US); Hal S. Alper, Cambridge, MA (US); Elke Nevoigt, Berlin (DE)

Correspondence Address: PEARL COHEN ZEDEK LATZER, LLP, 1500 BROADWAY 12TH FLOOR, NEW YORK, NY, 10036, US

(21) Appl. No.: 11/648,897

(22) Filed: Jan. 3, 2007

Related U.S. Application Data
(60) Provisional application No. 60/755,057, filed on Jan. 3, 2006.

(51) Int. Cl. C40B 30/06; C40B 40/02; C40B 40/10; C40B 50/06

(52) U.S. Cl. 435/6; 435/455; 435/325; 435/252.3; 435/471; 435/69.1

(57) ABSTRACT

The present invention relates to expression vectors, wherein each vector comprises at least one gene of interest and a promoter operatively linked thereto wherein each promoter comprises a nucleic acid, whose sequence is randomly mutated with respect to that of the wild-type promoter and cells comprising the same. Methods utilizing either the vectors or cells of this invention, in optimizing regulation of gene expression, protein expression, or optimized gene or protein delivery are described.

### CROSS-REFERENCE TO RELATED APPLICATIONS

This application claims priority from U.S. Provisional Patent Application Ser. No. 60/755,057 filed Jan. 3, 2006, which is hereby incorporated by reference in its entirety.

### FIELD OF THE INVENTION

This invention provides vectors or expression cassettes comprising promoters, wherein each promoter comprises a nucleic acid, whose sequence is randomly mutated with respect to that of the wild-type promoter and wherein the regulation of said promoter is modified. This invention also provides libraries and cells comprising the vectors. Methods utilizing the vectors, libraries, or cells of this invention, in optimizing regulation of gene expression, protein expression, or optimized gene or protein delivery are described.

### BACKGROUND OF THE INVENTION

Directed evolution has been extensively applied in protein engineering for the beneficial modification of proteins (properties such as antibody binding affinity, enzyme regulation, and increased or diverse substrate specificity) as well as to other biological sequences. Recently, this strategy has also been extended to promoters. In both prokaryotic and eukaryotic systems, random mutant libraries have been constructed which span a wide range in the strength of promoter-driven gene expression.

Regulatable promoters have been essential tools in basic and applied biological research, e.g. in functional genomics studies of essential genes, for the development of strains engineered to produce toxic proteins or metabolites as well as in gene therapy and agricultural research. Depending on the type of application, regulatable promoters require very specific regulatory properties which are often not satisfied by available native promoters or those customized via rational approaches. To date, a satisfactory method for effecting regulation of a promoter to provide optimal conditions of expression is lacking.

For example, an ideal regulatable promoter for industrial processes employing yeast as a biocatalyst must: i) be tightly regulated, ii) be inexpensive to induce, iii) express at high levels after induction and iv) be easy to handle. None of the systems available for inducing gene expression in Saccharomyces cerevisiae satisfies all these requirements. Most of them are leaky, inconvenient to use, and/or require expensive, toxic, or difficult-to-provide inducers, such as doxycycline, galactose, copper ions, heat, or even light.

### SUMMARY OF THE INVENTION

In one embodiment, this invention provides vectors or expression cassettes comprising regulatable promoters, wherein each promoter comprises a nucleic acid, whose sequence is randomly mutated with respect to that of the wild-type promoter and whose regulation has been altered as a result of the mutation. In one embodiment, altered regulation is reflected in levels of expression of a gene of interest, conditions of expression of a gene of interest, or a combination thereof.

In one embodiment, this invention provides an isolated nucleic acid comprising a mutated DAN1 promoter corresponding to or homologous to SEQ ID No: 1, 2, 3, 4, 5, 6, 7, 8, 9, or 10. In another embodiment, this invention provides an isolated nucleic acid comprising a mutated DAN1 promoter, wherein said promoter comprises a mutation in at least one nucleic acid at one or more of the following positions of SEQ ID No: 11: 1-56; 66-139; 148-232; 245-283; 290-293; 301-302; 310; 322-326; 334-347; 357-371; 380-450; or 458-551.

In another embodiment, this invention provides an isolated nucleic acid comprising a mutated DAN1 promoter, wherein said mutated promoter has a sequence comprising a replacement of: (a) a T with a C at nucleotide position 4, 15, 19, 36, 53, 56, 60, 66, 74, 75, 78, 86, 99, 132, 136, 176, 201, 205, 207, 216, 226, 228, 269, 277, 281, 285, 299, 303, 310, 327, 331, 332, 375, 376, 390, 428, 434, 467, 477, 480, 508, 511, or a combination thereof; (b) an A with a G at at nucleotide position 7, 18, 26, 40, 122, 135, 149, 153, 162, 164, 165, 171, 172, 187, 196, 211, 233, 234, 237, 241, 260, 274, 280, 308, 313, 322, 337, 343, 344, 346, 366, 368, 381, 384, 386, 396, 397, 402, 404, 422, 427, 429, 432, 445, 470, 490, 492, or a combination thereof; (c) a C with an A at nucleotide position 21; (d) an A with a C at nucleotide position 237, 338, 469, 514, 518; (e) a C with a T at nucleotide position 28, 296, 307, 373, 392, 528, or a combination thereof; (f) a G with an A at nucleotide position 22, 63, 391, 439 or a combination thereof; (g) a T with a G at nucleotide 198; or any combination thereof, of the sequence as set forth in SEQ ID NO: 11.

In one embodiment, the invention provides a method of optimized gene expression, wherein said gene is under the control of a regulatable promoter, said method comprising:
a. Contacting a plurality of cells with a library of expression vectors, each vector comprising at least one gene of interest and a regulatable promoter operatively linked thereto,
   wherein each promoter comprises a nucleic acid, whose sequence is randomly mutated with respect to that of another in said library, and whereby relative changes in expression level of said gene of interest under conditions, which regulate gene expression, are a function of the mutation in said promoter sequence;
b. Detecting gene expression levels of cells in (a) cultured under said conditions, which regulate gene expression; and
c. Identifying a cell from said plurality of cells in which expression levels under said conditions are optimized.

In another embodiment, the invention provides a method of regulating gene expression, said method comprising:
a. Contacting a plurality of cells with a library of expression vectors, each vector comprising at least one gene of interest and a regulatable promoter operatively linked thereto,
   wherein each promoter comprises a nucleic acid, whose sequence is randomly mutated with respect to that of another in said library, and
   whereby changes in an expression level of said gene, expression conditions of said gene of interest, or a combination thereof, of said gene of interest occur under regulatable conditions as a function of said mutation;
b. Detecting gene expression in said plurality of cells obtained in (i), under conditions where wild-type gene expression occurs sub-optimally;
c. Identifying a cell from said plurality of cells in which greater expression levels are obtained from said vectors, under conditions where wild-type gene expression occurs sub-optimally; and
d. Culturing said cell identified in (c) under said conditions.

According to these aspects of the invention, and in one embodiment, each vector in the library provides a consistent level of expression of the gene of interest, which, in another embodiment, is verified via at least two different methods. In one embodiment, the methods verify expression at a single cell level, and in another embodiment, may comprise fluorescent activated cell sorting analysis, fluorescence microscopy, or a combination thereof.

In another embodiment, the method further comprises identifying the promoter within the cell. In another embodiment, this invention provides a method of optimized regulation of protein delivery to a subject, comprising administering to a subject a vector comprising the promoter identified herein operatively linked to a gene encoding said protein of interest.

In another embodiment, this invention provides a cell with a desired expression level of a gene of interest, identified by a method of this invention. In one embodiment, the gene of interest is expressed under conditions that sub-optimally induce wild-type gene expression.

In another embodiment, this invention provides a method of optimized regulation of protein delivery to a subject, comprising administering to said subject a cell which has an optimized regulation of expression of the protein, identified via a method-of this invention. In one embodiment, the protein is expressed under conditions that sub-optimally induce wild-type protein expression.

In another embodiment, this invention provides a method of optimal regulation of production of a protein of interest under conditions that sub-optimally induce wild-type gene expression, said method comprising growing a cell of this invention under conditions that sub-optimally induce wild-type gene expression. In one embodiment, the cell is eukaryotic, while in another embodiment, it's prokaryotic.

### BRIEF DESCRIPTION OF THE FIGURES

FIG. 1 depicts the construction of the DAN1 promoter mutant library and selection of mutants responding more sensitively to oxygen depletion. a) The 552 bp fragment upstream of the DAN1 gene was cloned upstream of the reporter gene yECitrine giving rise to the plasmid p416-DAN-yECitrine. Error-prone PCR products of the native DAN1 promoter were expressed in the yeast strain BY4741 via recombinatorial cloning. b) Fluorescence histogram of the DAN1 promoter mutant library and an isogenic reference strain bearing the wild-type DAN1 promoter. Aerobic cultures were performed in shake flasks and fully repressed the promoter. For fastidious anaerobiosis, cultures were transferred to screw-capped vials and bubbled with nitrogen. Microaerobic conditions were obtained by transferring the cultures to screw-capped vials. Although most library clones had lower fluorescence intensity than the wild-type promoter, promoters with improved function were isolated by FACS separation of a very small faction of highly fluorescent clones, as shown in the rightmost panel.

FIG. 2 depicts a comparison of the performance of two selected DAN1 promoter mutants and the wild-type DAN1 promoter under varying oxygenation conditions as measured by yECitrine reporter gene protein and mRNA, and growth curves. Three yeast strains bearing either the native DAN1 promoter or one of the two selected DAN1 promoter mutants, respectively, upstream of the yECitrine reporter gene were cultivated under both aerobic and microaerobic conditions. Induction dynamics were monitored by A) reporter gene fluorescence and B) reporter mRNA transcript determination by RT-PCR. C) shows the growth curves for all three strains. Reporter gene fluorescence and mRNA transcript levels were normalized to an isogenic reference strain where the constitutive TEF1 promoter drove reporter gene expression.

FIG. 3A-B depicts multiple sequence alignment of the native DAN1 promoter and ten selected DAN1 promoter mutants. Mutant promoters 1-6 represent mutants which, after retransformation of plasmids, still showed a 1.8- to 2.9-fold higher induction by microaerobiosis than the wild-type DAN1 promoter. The underlined sequences correspond to the proposed transcription factor binding sites in the native DAN1 promoter according to Cohen et al. (Nucleic Acids Res 29:799-808, 2001).

FIG. 4 depicts the performance of the selected DAN1 promoter mutants and the wild-type DAN1 promoter under different fermentation conditions after bubbling the culture with nitrogen (Fastidious anaerobiosis) or cutting off the oxygen supply (Microaerobiosis), respectively. The top graphs present fluorescence of the yECitrine reporter gene during fastidious anaerobiosis and microaerobiosis, and the bottom graphs present growth curves of the three strains in each condition for up to 8 hours after removing oxygen supply. Reporter gene fluorescence levels were normalized to a reference strain.

### DETAILED DESCRIPTION OF THE INVENTION

This invention provides, in one embodiment, vectors or expression cassettes comprising promoters, wherein each promoter comprises a nucleic acid, whose sequence is randomly mutated with respect to that of the wild-type promoter and wherein the regulation of said promoter is modified. In one embodiment, the invention provides cells comprising the vectors. In one embodiment, the vectors are part of an expression library. In one embodiment, the promoters are operatively linked to at least one gene of interest. In one embodiment, the promoter is from a eurkaryotic cell. In another embodiment, the cells comprising the vectors are eukaryotic.

In one embodiment, one example of a regulatable promoter for which a customized design is needed is the DAN1 promoter of S. cerevisiae. The DAN1 promoter is inactive under aerobic conditions but highly active under anaerobic ones. The mechanism of regulation of this promoter is complex and involves at least four known transcription factors, which in turn respond to the decreased heme concentration caused by oxygen depletion. Fastidious anaerobiosis, which is required for efficient induction of the DAN1 promoter, has been achieved by bubbling cultures with nitrogen to deplete oxygen. Given the much lower mass transfer dynamics at large scales, this step could be time-consuming or impossible to implement under industrially relevant conditions. A more practical and convenient induction method would involve simple elimination or reduction of aeration, which would require introducing regulatory changes into the DAN1 promoter.

As is demonstrated herein, a derivative of the oxygen-regulated DAN1 promoter of S. cerevisiae was mutated through error-prone PCR and cloned into a plasmid upstream of a reporter gene. Highly productive mutants with 3-fold higher maximal expression in low oxygen conditions, were isolated, a somewhat unexpected finding, in view of the fact that regulation of gene expression in this system is complex and involves multiple transcription factors, repressors, etc. Thus, it would not be expected that random mutation would result in greater expression of a promoter with multiple levels of regulatory control. Further, promoter mutations altered conditions for induction of expression. As demonstrated herein, the mutated regulatable promoter drove greater gene expression at either anaerobic or microaerobic conditions than the wild-type promoter. Most remarkably, a promoter that was minimally inductive under microaerobic conditions appreciably drives expression under microaerobic conditions following the methods of this invention. Thus, the technology of the present invention regulates promoter sequences, in terms of, in some embodiments, promoting the type or strength of binding of regulatory factors to the promoter, the stringency of conditions with which induction occurs, promoter performance, or combinations thereof.

In one embodiment, this invention provides a library of expression vectors of this invention, each vector comprising at least one gene of interest and a regulatable promoter operatively linked thereto, wherein each promoter comprises a nucleic acid, whose sequence is randomly mutated with respect to that of another in the library. In one embodiment, the mutation results in an alteration of the regulation of the promoter. In one embodiment, the promoter is from a eurkaryotic cell. In another embodiment, the cells comprising the vectors are eukaryotic.

In one embodiment, the term “promoter” refers to a DNA sequence, which, in one embodiment, is directly upstream to the coding sequence and is important for basal and/or regulated transcription of a gene. In one embodiment, only a few nucleotides within a promoter are absolutely necessary for its function. In one embodiment, a promoter of the present invention is operatively linked to a gene of interest, while in another embodiment, it is not operatively linked to a gene of interest.

In one embodiment, the promoter is a mutant of the endogenous promoter, which is normally associated with expression of the gene of interest, under the appropriate conditions. In one embodiment, such promoters will be randomly mutated, and will comprise a library of this invention. In another embodiment, such mutants will be evaluated for their promoter strength, in terms of the resulting levels of expression of the gene of interest. In one embodiment, the expression will be validated by at least two means, and in another embodiment, expression will be assessed at a population and single cell level, as exemplified herein, or via any such means, as will be appreciated by one skilled in the art.

In another embodiment, the promoter is a regulatable promoter, which in one embodiment, refers to a promoter whereby expression of a gene downstream occurs as a function of the occurrence or provision of specific conditions which stimulate expression from the particular promoter. In some embodiments, such conditions result in directly turning on expression, or in other embodiments, remove impediments to expression. In some embodiments, such conditions result in turning off or reducing expression.

In one embodiment, such conditions may be a reflection of mainipulating culture conditions, for example, oxygen levels in the culture, such as, in some embodiments, microaerobic conditions, or, in another embodiment, anaerobic conditions. In another embodiment, such conditions may comprise specific temperatures, nutrients, absence of nutrients, presence of metals, or other stimuli or environmental factors as will be known to one skilled in the art. In one embodiment, a regulatable promoter may be regulated by galactose (e.g. UDP-galactose epimerase (GAL10), galactokinase (GAL1)), glucose (e.g. alcohol dehydrogenase II (ADH2)), or phosphate (e.g. acid phosphatase (PHO5)). In another embodiment, a regulatable promoter may be activated by heat shock (heat shock promoter) or chemicals such as IPTG or Tetracycline, or others, as will be known to one. skilled in the art. It is to be understood that any regulatable promoter, and conditions for such regulation is encompassed by the vectors, nucleic acids and methods of this invention, and represents an embodiment thereof. In one embodiment, a regulatable promoter may be GAL1, GAL2, GAL3, GAL4, GAL5, GAL6, GAL7, GAL8, GAL9, GAL10, MET3, MET25, tetracycline, or CUP1 promoter.

In one embodiment, this invention provides an isolated nucleic acid comprising a mutated DAN1 promoter corresponding to or homologous to SEQ ID No: 1, 2, 3, 4, 5, 6, 7, 8, 9, or 10. In one embodiment, this invention provides an isolated nucleic acid comprising a mutated DAN1 promoter corresponding to or homologous to SEQ ID No: 1, 2, 3, 4, 5, or 6. In one embodiment, this invention provides an isolated nucleic acid comprising a mutated DAN1 promoter corresponding to or homologous to SEQ ID No: 1 or 2. In another embodiment, this invention provides an isolated nucleic acid comprising a mutated DAN1 promoter, wherein said promoter comprises a mutation in at least one nucleic acid at one or more of the following positions of SEQ ID No: 11: 1-56; 66-139; 148-232; 245-283; 290-293; 301-302; 310; 322-326; 334-347; 357-371; 380-450; or 458-551. According to this aspect and in one embodiment, the mutation is at position: 4, 7, 15, 18, 19, 21, 22, 26, 28, 36, 40, 53, 56, 60, 63, 66, 74, 75, 78, 86, 99, 122, 132, 135, 136, 149, 153, 162, 164, 165, 171, 172, 176, 187, 196, 198, 201, 205, 207, 211, 216, 226, 228, 233, 234, 237, 241, 260, 269, 274, 277, 280, 281, 285, 296, 299, 303, 307, 308, 310, 313, 322, 327, 331, 332, 337, 338, 343, 344, 346, 366, 368, 373, 375, 376, 381, 384, 386, 390, 391, 392, 396, 397, 402, 404, 422, 427, 428, 429, 432, 434, 439, 445, 467, 469, 470, 477, 480, 490, 492, 508, 511, 514, 518, 528, or a combination thereof. In one embodiment, mutations at these positions may be to any nucleotide other than the wild-type nucleotide, while in another embodiment, mutations at each position is to a specific nucleotide as described hereinbelow.

In another embodiment, this invention provides an isolated nucleic acid comprising a mutated DAN1 promoter, wherein said mutated promoter has a sequence comprising a replacement of: (a) a T with a C at nucleotide position 4, 15, 19, 36, 53, 56, 60, 66, 74, 75, 78, 86, 99, 132, 136, 176, 201, 205, 207, 216, 226, 228, 269, 277, 281, 285, 299, 303, 310, 327, 331, 332, 375, 376, 390, 428, 434, 467, 477, 480, 508, 511, or a combination thereof; (b) an A with a G at at nucleotide position 7, 18, 26, 40, 122, 135, 149, 153, 162, 164, 165, 171, 172, 187, 196, 211, 233, 234, 237, 241, 260, 274, 280, 308, 313, 322, 337, 343, 344, 346, 366, 368, 381, 384, 386, 396, 397, 402, 404, 422, 427, 429, 432, 445, 470, 490, 492, or a combination thereof; (c) a C with an A at nucleotide position 21; (d) an A with a C at nucleotide position 237, 338, 469, 514, 518; (e) a C with a T at nucleotide position 28, 296, 307, 373, 392, 528, or a combination thereof; (f) a G with an A at nucleotide position 22, 63, 391, 439 or a combination thereof; (g) a T with a G at nucleotide 198; or any combination thereof, of the sequence as set forth in SEQ ID NO: 11.

It is to be understood that mutations of nucleotide positions other than those described hereinabove are to be considered a part of this invention. In one embodiment, mutations in a portion of a promoter that is structurally or functionally homologous to the portion of the DAN1 promoter mutated as described herein is to be considered a part of the present invention. In another embodiment, the present invention includes mutations in a promoter that is homologous to the DAN1 promoter. In one embodiment, homologous promoters or portions thereof are derived from S. cerevisiae sequences, while in another embodiment, they are derived from other Saccharomyces species, while in another embodiment, they are derived from Saccharomycetaceae, while in another embodiment, they are derived from Saccharomycetales, while in another embodiment, they are derived from Saccharomycetes, while in another embodiment, they are derived from Saccharomycotina, while in another embodiment, they are derived from Ascomycota, while in another embodiment, they are derived from fungal species. In another embodiment, promoters homologous to the DAN1 promoter show similar oxygen dependency as the DAN1 promoter. One of skill in the art would be able to determine the oxygen dependency of a promoter using methods that are routine in the art. Determinations of homologous promoters or promoter regions are made routinely by those of skill in the art using tools known in the art such as sequence alignments.

In one embodiment, a homologous promoter to DAN1 is DAN2, DAN3, DAN4, TIR1, TIR2, TIR3, or TIR4. In another embodiment, a homologous promoter to DAN1 is CYC1, CYC7, ANB1, COX5b, ERG11, MOX1, MOX2, MOX4/UPC2, ROX7/MOT3, or ROX1 promoters.

In one embodiment, mutations may be in a portion of a promoter corresponding to anaerobic response elements binding sites, which in one embodiment is AR1 or AR2, while in another embodiment, mutations may be in Mot3 or Rox1 binding sites.

In some embodiments, a composition of the present invention will comprise a nucleic acid, vector or library comprising a DAN1 promoter or a DAN1 promoter homolog comprising any one or more mutations or according to any embodiment, as described herein. In some embodiments, a composition of the present invention will consist of a nucleic acid, vector or library comprising a DAN1 promoter or a DAN1 promoter homolog comprising any one or more mutations or according to any embodiment, as described herein. In some embodiments, a composition of the present invention will consist essentially of a nucleic acid, vector or library comprising a DAN1 promoter or a DAN1 promoter homolog comprising any one or more mutations or according to any embodiment, as described herein. In some embodiments, a nucleic acid, vector or library of the present invention will consist essentially of a gene of interest operably linked to a single promoter, which in one embodiment, is a DAN1 promoter, while in another embodiment, is a DAN1 promoter homolog.

The term “homology”, as used herein, when in reference to any nucleic acid sequence indicates a percentage of nucleotides in a candidate sequence that are identical with the nucleotides of a corresponding native nucleic acid sequence.

In one embodiment, the terms “homology”, “homologue” or “homologous”, in any instance, indicate that the sequence referred to, exhibits, in one embodiment at least 70% correspondence with the indicated sequence. In another embodiment, the nucleic acid sequence exhibits at least 72% correspondence with the indicated sequence. In another embodiment, the nucleic acid sequence exhibits at least 75% correspondence with the indicated sequence. In another embodiment, the nucleic acid sequence exhibits at least 77% correspondence with the indicated sequence. In another embodiment, the nucleic acid sequence exhibits at least 80% correspondence with the indicated sequence. In another embodiment, the nucleic acid sequence exhibits at least 82% correspondence with the indicated sequence. In another embodiment, the nucleic acid sequence exhibits at least 85% correspondence with the indicated sequence. In another embodiment, the nucleic acid sequence exhibits at least 87% correspondence with the indicated sequence. In another embodiment, the nucleic acid sequence exhibits at least 90% correspondence with the indicated sequence. In another embodiment, the nucleic acid sequence exhibits at least 92% correspondence with the indicated sequence. In another embodiment, the nucleic acid sequence exhibits at least 95% or more correspondence with the indicated sequence. In another embodiment, the nucleic acid sequence exhibits 95%-100% correspondence to the indicated sequence. Similarly, reference to a correspondence to a particular sequence includes both direct correspondence, as well as homology to that sequence as herein defined.

Homology may be determined by computer algorithm for sequence alignment, by methods well described in the art. For example, computer algorithm analysis of nucleic acid sequence homology may include the utilization of any number of software packages available, such as, for example, the BLAST, DOMAIN, BEAUTY (BLAST Enhanced Alignment Utility), GENPEPT and TREMBL packages.

An additional means of determining homology is via determination of candidate sequence hybridization, methods of which are well described in the art (See, for example, “Nucleic Acid Hybridization” Hames, B. D., and Higgins S. J., Eds. (1985); Sambrook et al., 1989, Molecular Cloning, A Laboratory Manual, (Volumes 1-3) Cold Spring Harbor Press, New York; and Ausubel et al., 1989, Current Protocols in Molecular Biology, Green Publishing Associates and Wiley Interscience, New York). For example, methods of hybridization may be carried out under moderate to stringent conditions, to the complement of a DNA encoding a native caspase peptide. Hybridization conditions being, for example, overnight incubation at 42° C. in a solution comprising: 10-20% formamide, 5×SSC (150 mM NaCl, 15 mM trisodium citrate), 50 mM sodium phosphate (pH 7. 6), 5× Denhardt's solution, 10% dextran sulfate, and 20 μg/ml denatured, sheared salmon sperm DNA.

In one embodiment, the libraries described in the present invention are constructed from nucleic acid fragments comprising genomic DNA, cDNA, or amplified nucleic acid. In one embodiment, the promoters, and/or, in another embodiment, the gene of interest, or, in another embodiment, genes of interest, under the control of the promoter, are derived from one or two, or more genomes, which, in another embodiment, may be well-characterized genomes.

The nucleic acids used in this invention can be produced by any synthetic or recombinant process such as is well known in the art. Nucleic acids can further be modified to alter biophysical or biological properties by means of techniques known in the art. For example, the nucleic acid can be modified to increase its stability against nucleases (e.g., “end-capping”), or to modify its lipophilicity, solubility, or binding affinity to complementary sequences. These nucleic acids may comprise the vector, the expression cassette, the promoter sequence, the gene of interest, or any combination thereof.

DNA according to the invention can also be chemically synthesized by methods known in the art. For example, the DNA can be synthesized chemically from the four nucleotides in whole or in part by methods known in the art. Such methods include those described in Caruthers (1985). DNA can also be synthesized by preparing overlapping double-stranded oligonucleotides, filling in the gaps, and ligating the ends together (see, generally, Sambrook et al. (1989) and Glover et al. (1995)). DNA expressing functional homologues of the protein can be prepared from wild-type DNA by site-directed mutagenesis (see, for example, Zoller et al. (1982); Zoller (1983); and Zoller (1984); McPherson (1991)). The DNA obtained can be amplified by methods known in the art. One suitable method is the polymerase chain reaction (PCR) method described in Saiki et al. (1988), Mullis et al., U.S. Pat. No.4,683,195, and Sambrook et al. (1989).

In one embodiment, the genome selected is one that is well-characterized. In one embodiment, the genome is a compact genome of a eukaryote (ie. protist, dinoflagellate, alga, plant, fungus, mould, invertebrate, vertebrate, etc) such as, for example, a eukaryote from: Arabidopsis thaliana, Anopheles gambiae, Caenorhabditis elegans, Danio rerio, Drosophila melanogaster, Takifugu rubripes, Cryptosporidium parvum, Trypanosoma cruzii, Saccharomyces cerevesiae, and Schizosaccharomyces pombe. In another embodiment, the genome is murine, rat, simian or human.

In another embodiment, the genome is a compact genome of a prokaryote (ie. bacteria, eubacteria, cyanobacteria, etc) such as, for example a prokaryote from: Archaeoglobus julgidis, Aquifex aeolicus, Aeropyrum pernix, Bacillus subtilis, Bordetella pertussis TOX6, Borrelia burgdorferi, Chlamydia trachomatis, Escherichia coli K12, Haemophilus influenzae (rd), Helicobacter pylori, Methanobacterium thermoautotrophicum, Methanococcus jannaschii, Mycoplasma pneumoniae, Neisseria meningitidis, Pseudomonas aeruginosa, Pyrococcus horikoshii, Synechocystis PCC 6803, Thermoplasma volcanium, or Thermotoga maritima.

In another embodiment, the promoter library may be derived from sequences from Actinobacillus pleuropneumoniae, Aeropyrum pernix, Agrobacterium tumefaciens, Anopheles gambiae, Aquifex aeolicus, Arabidopsis thaliana, Archeglobus fulgidis, Bacillus anthracis, Bacillus cereus, Bacillus halodurans, Bacillus subtilis, Bacteroides thetaiotaomicron, Bdellovibrio bacteriovorus, Bifidobacterium longum, Bordetella bronchiseptica, Bordetella pertussis, Borrelia burgdorferi, Bradyrhizobium japonicum, Brucella melitensis, Brucella suis, Bruchnera aphidicola, Brugia malayi, Caenorhabditis elegans, Canipylobacter jejuni, Candidatus blochmanniafloridanus, Caulobacter crescentus, Chlamydia muridarum, Chlamydia trachomatis, Chlamydophila caviae, Chlamydia pneumoniae, Chlorobium tepidum, Chromobacterium violaceum, Clostridium acetobutylicum, Clostridium perfringens, Clostridium tetani, Corynebacterium diphtheriae, Corynebacterium efficiens, Corynebacterium glutamicum, Coxiella burnetii, Danio rerio, Dechloromonas aromatica, Deinococcus radiodurans, Drosophila melanogaster, Eimeria tenella, Eimeria acervulina, Entamoeba histolytica, Enterococcus faecalis, Escherichia coli, Fusobacterium nucleatum, Geobacter Sulfurreducens, Gloeobacter violaceus, Haemophilis ducreyi, Haemophilus influenzae, Halobacterium, Helicobacter hepaticus, Helicobacter pylori, Lactobacillus johnsonii, Lactobacillus plantarum, Lactococcus lactis, Leptospira interrogans serovar lai, Listeria innocua, Listeria monocytogenes, Mesorhizobium loti, Methanobacter thermoautotrophicus, Methanocaldocossus jannaschii, Methanococcoides burtonii, Methanopyrus kandleri, Methanosarcina acetivorans, Methanosarcina mazei Goel, Mycobacterium avium, Mycobacterium bovis, Mycobacterium leprae, Mycobacterium tuberculosis, Mycoplasma gallisepticum strain R, Mycoplasma genitalium, Mycoplasma penetrans, Mycoplasma pneumoniae, Mycoplasma pulmonis, Nanoarchaeum equitans, Neisseria meningitidis, Nitrosomonas europaea, Nostoc, Oceanobacillus iheyensis, Onion yellows phytoplasma, Oryzias latipes, Oryza sativa, Pasteurella multocida, Photorhabdus luminescens, Pirellula, Plasmodium falciparum, Plasmodium vivax, Plasmodium yoelii, Porphyromonas gingivalis, Prochlorococcus marinus, Pseudomonas aeruginosa, Pseudomonas putida, Pseudomonas syringae, Pyrobaculum aerophilum, Pyrococcus abyssi, Pyrococcus furiosus, Pyrococcus horikoshii, Ralstonia solanacearum, Rhodopseudomonas palustris, Rickettsia conorii, Rickettsia prowazekii, Rickettsia rickettsii, Saccharomyces cerevisiae, Salmonella enterica, Salmonella typhimurium, Sarcocystis cruzi, Schistosoma mansoni, Schizosaccharomyces pombe, Shewanella oneidensis, Shigella flexneri, Sinorhizobium meliloti, Staphylococcus aureus, Staphylococcus epidermidis, Streptococcus agalactiae, Streptococcus agalactiae, Streptococcus mutans, Streptococcus pneumoniae, Streptococcus pyogenes, Streptomyces avermitilis, Streptomyces coelicolor, Suffiblobus tokodaii, Synechocystis sp., Takifugu rubripes, Tetraodon fluviatilis, Theileria parva, Thermoanaerobacter tengcongensis, Thermoplasma acidophilum, Thermoplasma voleanium, Thermosynechococcus elongatus, Aermotoga maritima, Toxoplasma gondii, Treponema denticola, Treponema pallidum, Tropheryma whipplei, Trypanosoma brucei, Trypanosoma cruzi, Ureaplasma urealyticum, Vibrio cholerae, Vibrio parahaemolyticus, Vibrio vulnificus, Wigglesworthia glossinidia endosymbiont of Glossina brevipalpis, Wolbachia endosymbiont of Drosophilia melanogaster, Wolinella succinogenes, Xanthomonas axonopodis pv. Citri, Xanthomonas campestris pv. Campestris, Xylella fastidiosa, or Yersinia pestis.

In another embodiment, nucleic acid fragments are derived from viral genomes, such as, for example: T7 phage, HIV, equine arteritis virus, lactate dehydrogenase-elevating virus, lelystad virus, porcine reproductive and respiratory syndrome virus, simian hemorrhagic fever virus, avian nephritis virus, turkey astrovirus, human asterovirus type 1, 2 or 8, mink astrovirus 1, ovine astrovirus 1, avian infectious bronchitis virus, bovine coronavirus, human coronavirus, murine hepatitis virus, porcine epidemic diarrhea virus, SARS coronavirus, transmissible gastroenterifis virus, acute bee paralysis virus, aphid lethal paralysis virus, black queen cell virus, cricket paralysis virus, Drosophila C virus, himetobi P virus, kashmir been virus, plautia, stali intestine virus, rhopalosiphutn padi virus, taura syndrome virus, triatoma virus, allchunna virus, apoi virus, cell fusing agent virus, deer tick virus, dengue virus type 1, 2, 3 or 4, Japanese encephalitis virus, Kamiti River virus, kunjin virus, langat virus, louping ill virus, modoc virus, Montana myotis leukoencephalitis virus, Murray Valley encephalitis virus, omsk hemorrhagic fever virus, powassan virus, Rio Bravo virus, Tamana bat virus, tick-borne encephalitis virus, West Nile virus, yellow fever virus, yokose virus, Hepatitis C virus, border disease virus, bovine viral diarrhea virus I or 2, classical swine fever virus, pestivirus giraffe, pestivirus reindeer, GB virus C, hepatitis G virus, hepatitis GB virus, bacteriophage Ml 1, bacteriophage Qbeta, bacteriophage SP, enterobacteria phage MXI, enterobacteria NL95, bacteriophage AP205, enterobacteria phage fr, enterobacteria phage GA, enterobacteria phage KU1, enterobacteria phage M12, enterobacteria phage MS2, pseudomonas phage PP7, pea enation mosaic virus-1, barley yellow dwarf virus, barley yellow dwarf virusGAV, barley yellow dwarf virus-MAW, barley yellow dwarf virus-PAS, barley yellow dwarf virus-PAV, bean leafroll virus, soybean dwarf virus, beet chlorosis virus, beet mild yellowing virus, beet western yellows virus, cereal yellow dwarf virus-RPS, cereal yellow dwarf virus-RPV, cucurbit aphid-borne yellows virus, potato leafroll. virus, turnip yellows virus, sugarcane yellow leaf virus, equine rhinitis A virus, foot-and mouth disease virus, encephalomyocarditis virus, theilovirus, bovine enterovirus, human enterovirus A, B, C, D or E, poliovirus, porcine enterovirus A or B, -unclassified enterovirus, equine rhinitis B virus, hepatitis A virus, aichi virus, human parechovirus 1, 2 or 3, Ijungan virus, equine rhinovirus 3, human rhinovirus A and B, porcine teschovirus 1, 2-7, 8, 9, 10 or 11, avian encephalomyelitis virus, kakago virus, simian picornavirus 1, aura virus, bartnah forest virus, chikungunya virus, eastern equine encephalitis virus, igbo ora virus, mayaro virus, ockelbo virus, onyong-nyong virus, Ross river virus, sagiyama virus, salmon pancrease disease virus, semliki forest virus, sindbis virus, sindbus-like virus, sleeping disease virus, Venezuelan equine encephalitis virus, Western equine encephalomyelitis virus, rubella virus, grapevine fleck virus, maize rayado fino virus, oat blue dwarf virus, chayote mosaic tymovirus, eggplant mosaic virus, erysimum latent virus, kennedya yellow mosaic virus, ononis yellow mosaic virus, physalis mottle virus, turnip yellow mosaic virus or poinsettia mosaic virus.

In another embodiment, the genome is the human genome, or from Mus or Rattus genuses. In another embodiment, the genome is simian.

In another embodiment, the nucleic acid, vector, or library of the instant invention may be introduced into any organism as is listed hereinabove or known to those of skill in the art, which in one embodiment, allows desired expression of a particular gene in a particular organism under specific conditions, which in one embodiment, relate to available oxygen levels.

Information regarding sequenced viruses and/or bacteria and/or other sources, such as animals or humans is readily obtained from publicly available sources, such as, for example, the databases of National Center for Biotechnological Information, Entrez Genomes (NCBI), the Sangre Center, the Institute for Genomic Research (TIGR), the National Center for Genome Resources, or others.

In one embodiment, when nucleic acid fragments are from mixtures of organisms, the organisms are not normally found together in nature. In accordance with this embodiment of the invention, the process of combining nucleic acid fragments derived from diverse organisms not normally found together in nature enhances and controls diversity of the expression library produced using such nucleic acid fragments.

It is to be understood that the nucleic acid fragments used in the production of the expression cassettes or expression libraries of the present invention are generated using art—recognized methods such as, for example, a method selected from the group comprising mechanical shearing, digestion with a nuclease and digestion with a restriction endonuclease.

Combinations of such methods can also be used to generate the genome fragments, which comprise the promoters and/or gene/s of interest, of which the expression cassettes and/or libraries of this invention are comprised, and/or are used in the methods of this invention. In one embodiment, copies of nucleic acid fragments from one or two or more genomes are generated using polymerase chain reaction (PCR) using random oligonucleotide primers.

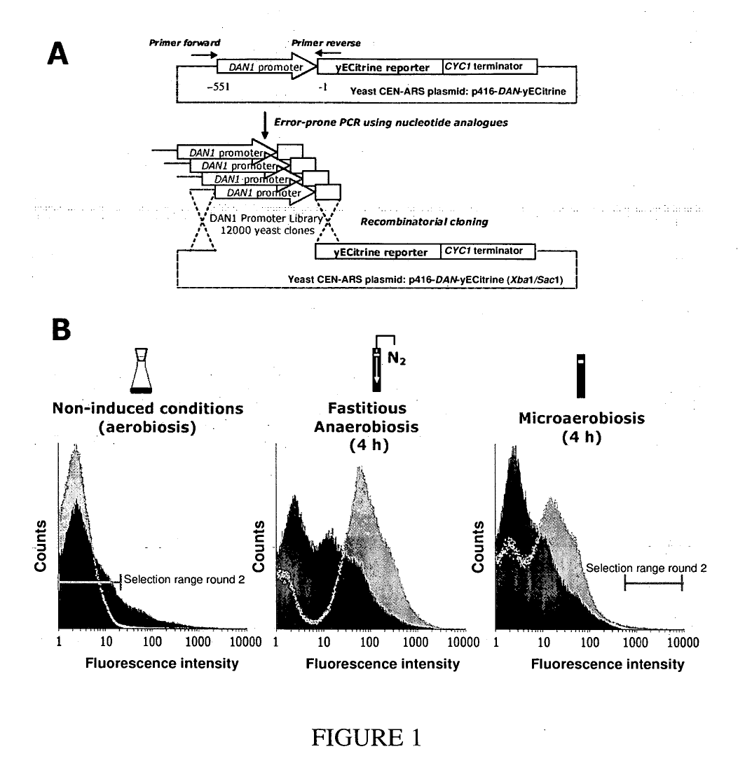

In another embodiment, the cassettes or genomes are randomly mutated by any means known in the art, such as, for example, chemical mutagenesis, or via the use of error-prone PCR, as known in the art, and exemplified herein. A derivative of the regulatable S. cerevisiae BY4741 DAN1 promoter was mutated through error-prone PCR, cloned into a reporter plasmid upstream of a yECitrine gene, and screened in S. cerevisiae strain BY4741 based on the fluorescence signal in a glucose YPD medium. A functional promoter library of mutants was formed, wherein reproducible and homogeneous fluorescence distributions were measured by flow cytometry (FIG. 1).

In another embodiment, the methods of inducing random mutations using PCR are known in the art and, are described, for example, in Dieffenbach (ed) and Dveksler (ed) (In: PCR Primer: A Laboratory Manual, Cold Spring Harbour Laboratories, New York, 1995). In another embodiment, commercially available kits for use in mutagenic PCR are utilized, such as, for example, the Diversify PCR Random Mutagenesis Kit (Clontech) or the GeneMorph Random Mutagenesis Kit (Stratagene).

In one embodiment, PCR reactions are performed in the presence of at least about 200 mM manganese or a salt thereof. Such concentrations of manganese ion or a manganese salt induce from about 2 mutations per 1000 base pairs (bp) to about 10 mutations every 1000 bp of amplified nucleic acid (Leung et al., Technique 1, 11-15, 1989).

In another embodiment, PCR reactions are performed in the presence of an elevated or increased or high concentration of dGTP, for example, between about 150 mM and about 200 mM. Such high concentrations of dGTP result in the misincorporation of nucleotides into PCR products at a rate of between about 1 nucleotide and about 3 nucleotides every 1000 bp of amplified nucleic acid (Shahani et al., BioTechniques 23, 304-306, 1997).

In another embodiment, the nucleic acid of the expression cassette and/or library is mutated by insertion into a host cell that is capable of mutating the nucleic acid. Such host cells are deficient in one or more enzymes, such as, for example, one or more recombination or DNA repair enzymes, thereby enhancing the rate of mutation to a rate that is rate approximately 5,000 to 10,000 times higher than for non-mutant cells.

In one embodiment, strains useful for the mutation of nucleic acids carry alleles that modify or inactivate components of the mismatch repair pathway. Examples of such alleles include muff, mutM, mutD, muff, mutA, mutC or mutS. Bacterial cells that carry alleles that modify or inactivate components of the mismatch repair pathway are known in the art, such as, for example the XLlRed, XL-mutS and XL-mutS-Kad bacterial cells (Stratagene).

In another embodiment, the nucleic acid fragments may be cloned into a nucleic acid vector that is preferentially replicated in a bacterial cell by the repair polymerase, Pol I. A Pol I variant strain which induces a high level of mutations in the introduced nucleic acid vector, may be used, in one embodiment, adapting the method described by Fabret et al (In: Nucl Acid Res, 28, 1-5 2000), which is incorporated herein by reference.

In another embodiment, the mutagenized library may be constructed using transposons. In one embodiment, the mariner transposon may be used. Mariner transposition occurs efficiently in vitro, does not require cellular cofactors and shows very little insertion site specificity, requiring only the dinucleotide TA in the target sequence (and even this minor site specificity can be easily altered using different in vitro reaction conditions). In another embodiment, the Tn7 transposon may be used.

Transposons occur naturally as DNA sequences coding for an enzyme, transposase, which recognizes and cuts the DNA at sites flanking the gene for the transposase. The recognition sites, or binding sites for the transposase, are referred to as inverted repeat sequence. As such, transposable elements, when activated, produce an enzyme, which promotes the excision of itself from one location in DNA and the insertion of the excised DNA at another site. In some embodiments, the transposon selected will exhibit site-specific insertion at so-called “hot spots.”

In another embodiment, the transposon may be Tn55 1, Minos, Hermes or piggyback. In another embodiment, the transposon may be AT-2 (ty1 based transposon, Perkin Elmer; Devine et al. (1997) Genome Res. 7:551-563), GPS-1 (New England Biolabs), GPS-2 (New England Biolabs), EZ::tn (Tn5 based transposon, Epicenter Technologies), SIF (Tn7 based transposon, Biery et al. (2000) Nucl Acid Res 28:1067-1077), or Mu (Finnzymes, Haapa et al. (1999) Nucl Acid Res 13:2777-2784). It is to be understood that any transposon may be used in the methods of this invention.

The transposons will be employed, in one embodiment, with their natural cognate transposases, or in another embodiment, with the use of modified and/or improved transposases.

In another embodiment, the transposon may comprise a nucleic acid sequence encoding a heterologous polypeptide. This sequence may be integrated, together with the transposon, into the genome of the cell on transposon integration. In one embodiment, the heterologous polypeptide may be excised, together with the transposon, when the latter excises on remobilization. In one embodiment, the heterologous polypeptide is a detectable marker, such as, for example, the green fluorescent protein (GFP), or mutants, homologues thereof.

GFPs have been isolated from the Pacific Northwest jellyfish, Aequorea Victoria, from the sea pansy, Renilla reniformis, and from Phialidium gregarium. (Ward et al., 1982, Photochem. Photobiol., 35: 803-808; Levine et al., 1982, Comp. Biochem. Physiol.,72B: 77-85). See also Matz, et al., 1999, ibid for fluorescent proteins isolated recently from Anthoza species (accession nos. AF168419, AF168420, AF168421, AF168422, AF168423 and AF168424), each of which may be incorporated in the methods of this invention.

A variety of Aequorea-related GFPs having useful excitation and emission spectra have been engineered by modifying the amino acid sequence of a naturally occurring GFP from Aequorea victoria (Prasher et al., 1992, Gene, 111: 229-233; Heim et al., 1994, Proc. Natl. Acad. Sci. U.S.A., 91: 12501-12504; PCT/US95/14692).

In another embodiment, in vitro transposition may be conducted upon genomic DNA cloned into a vector, for example a cosmid, phage, plasmid, YAC (yeast artificial chromosome), or BAC (bacterial artificial chromosome) vector. Similar high-density mutagenesis can be performed in non-naturally competent organisms using genomic DNA cloned into an allelic replacement vector (see for example, U.S. Pat. No. 6,207,384).

In one embodiment, chromosomal DNA from the cell of interest is isolated and mutagenized with the Himar1 transposase and, in another embodiment, an artificial minitransposon encoding a marker gene, such as, for example, the gene for either kanamycin or chloramphenicol resistance.

Insertion of the transposon produces a short single-stranded gap on either end of the insertion site. In one embodiment, bacterial strains, which are known to take up single stranded DNA are utilized, and according to this aspect of the invention, these gaps may require repair (using a DNA polymerase and a DNA ligase) to produce the flanking DNA sequence required for recombination into the chromosome.

In another embodiment, the mutagenized cassettes and/or libraries are constructed via the use of radiation. When creating mutations through radiation, in one embodiment, ultraviolet (UV) or, in another embodiment, ionizing radiation may be used. Suitable short wave UV wavelengths for genetic mutations may fall within the range of 200 nm to 300 nm, in one embodiment, where 254 nm is preferred. UV radiation in this wavelength principally causes changes within nucleic acid sequence from guanidine and cytosine to adenine and thymidine. Since all cells have DNA repair mechanisms that would repair most UV induced mutations, agents such as caffeine and other inhibitors may be added to interrupt the repair process and maximize the number of effective mutations. Long wave UV mutations using light in the 300 nm to 400 nm range may be used, in another embodiment, and may be used in conjunction with various activators such as psoralen dyes that interact with DNA, in another embodiment.

In another embodiment, mutagenesis with chemical agents may also be used. Such chemical mutagens may comprise, in other embodiments, chemicals that affect nonreplicating DNA such as HNO₂ and NH₂OH, as well as agents that affect replicating DNA such as acridine dyes, which have been shown to cause frameshift mutations. Methods for creating mutants using radiation or chemical agents are well known in the art, and any method may be utilized for the methods of this invention (see, for example, Thomas D. Brock in Biotechnology: A Textbook of Industrial Microbiology, Second Edition (1989) Sinauer Associates, Inc., Sunderland, M A., or Deshpande, Mukund V., Appl. Biochem. Biotechnol. 36, 227 (1992).

Mutagenized DNA is transformed into bacteria, in one embodiment, or other cells of interest, in another embodiment, by methods well known and described in the art (see for example, “Methods in Enzymology” Vol. 1-317, Academic Press, Current Protocols in Molecular Biology, Ausubel F. M. et al. (eds.) Greene Publishing Associates, (1989) and in Molecular Cloning: A Laboratory Manual, 2nd Edition, Sambrook et al. Cold Spring Harbor Laboratory Press, (1989), or other standard laboratory manuals). Cells, which acquire transposon insertions by homologous recombination, are selected, for example, via plating on an appropriate antibiotic-containing medium. In another embodiment, cells may be selected using fluorescence-activated cell sorting.

In one embodiment, southern blot analysis of digested DNA from individual transposon mutants to verify transposon insertion, or in another embodiment, from individual mutagenized cells. In another embodiment, sequence analysis, PCR and/or hybridization may be utilized to determine mutagenesis by, for example transposon insertion, or error-prone PCR, etc.

Screening of the mutagenized library obtained, as exemplified herein, using flow cytometry identified cells with varying expression of the reporter gene under variable conditions, which were a function of the mutations introduced into the promoter, which comprises embodiments of this invention. It is to be understood that other promoters, and thereby mutations involved in regulated expression in such promoters, may be identified via the methods of this invention, as described herein. The method of identification, as well as strains obtained thereby, are to be considered as part of this invention.

It is to be understood that any method whereby random mutations are generated in promoter sequences may be used to generate the cassettes, libraries and/or vectors of this invention, and are to be considered an embodiment thereof. It is also to be understood that such methods may be combined, and comprise additional embodiments of the invention.

In one embodiment, the cassettes and/or vectors comprise nucleic acid fragments or cDNA or amplified DNA derived therefrom in operable connection with a gene, whose expression is desired. The construct used for the regulated expression of the gene under the control of the diverse promoter library may also comprise cassettes, which facilitate screening for expression on a qualitative and quantitative level. Thus, in one embodiment, an expression format suitable for screening the library is considered.

In one embodiment, the term “vector” in the present invention, may refer to a nucleic acid construct which further includes an origin of replication, and may be a shuttle vector, which can propagate both in prokaryotic, and in eukaryotic cells, or the vector may be constructed to facilitate its integration within the genome of an organism of choice. The vector, in other embodiments may be, for example, a plasmid, a bacmid, a phagemid, a cosmid, a phage, a virus or an artificial chromosome.

In one embodiment, the term “expression cassette” or “cassette” may refer to a nucleic acid which comprises a promoter sequence and a gene operatively linked thereto, wherein the promoter may be mutated, as described herein, for provision of an optimized regulation of expression of said gene of interest for a particular application. In one embodiment, the cassette may be in any location, for example, it may be ligated within an expression vector, as described, or the cassette may be so engineered that it may integrate within a chromosome of a cell of interest.

In another embodiment, the cassette and/or vector contemplated by this invention further comprises an insertion of a heterologous nucleic acid sequence encoding a marker polypeptide. The marker polypeptide may comprise, for example, yECitrine, green fluorescent protein (GFP), DS-Red (red fluorescent protein), secreted alkaline phosphatase (SEAP), beta-galactosidase, luciferase, or any number of other reporter proteins known to one skilled in the art.

In one embodiment, the term “optimized” refers to a desired change, which, in one embodiment, is a change in gene expression and, in another embodiment, in protein expression. In one embodiment, optimized gene expression is optimized regulation of gene expression. In another embodiment, optimized gene expression is an increase in gene expression. According to this aspect and in one embodiment, a 2-fold through 1000-fold increase in gene expression compared to wild-type is contemplated. In another embodiment, a 2-fold to 500-fold increase in gene expression, in another embodiment, a 2-fold to 100-fold increase in gene expression, in another embodiment, a 2-fold to 50-fold increase in gene expression, in another embodiment, a 2-fold to 20-fold increase in gene expression, in another embodiment, a 2-fold to 10-fold increase in gene expression, in another embodiment, a 3-fold to 5-fold increase in gene expression is contemplated. In another embodiment, optimized gene expression may be an increase in gene expression under particular environmental conditions. In another embodiment, optimized gene expression may comprise a decrease in gene expression, which, in one embodiment, may be only under particular environmental conditions.

In one embodiment, the term “gene” refers to a nucleic acid fragment that is capable of being expressed as a specific protein, including regulatory sequences preceding (5′ non-coding sequences) and following (3′ non-coding sequences) the coding sequence. “Native gene” refers to a gene as found in nature with its own regulatory sequences. “Chimeric gene” refers to any gene that is not a native gene, comprising regulatory and coding sequences that are not found together in nature. Accordingly, a chimeric gene may comprise regulatory sequences and coding sequences that are derived from different sources, or regulatory sequences and coding sequences derived from the same source, but arranged in a manner different than that found in nature. “Endogenous gene” refers to a native gene in its natural location in the genome of an organism. A “foreign” gene refers to a gene not normally found in the host organism, but that is introduced into the host organism by gene transfer. Foreign genes can comprise native genes inserted into a non-native organism, or chimeric genes. A “transgene” is a gene that has been introduced into the genome by a transformation procedure.

Regulated expression of the genes of interest may be accomplished using the cassettes, vectors and/or libraries of this invention, and via any means as will be known to one skilled in the art. In one embodiment, such expression may be effected in genetically engineered bacteria, eukaryotic cells such as yeast, and/or mammalian cells, and such cells are to be considered as part of this invention. In one embodiment, a construct is introduced in the prokaryotes or eukaryotes, such that it is possible to select for homologous recombination events in the cell. One of ordinary skill in the art can readily design such a construct including both positive and negative selection genes for efficiently selecting transfected cells that underwent a homologous recombination event with the construct.

There are a number of techniques known in the art for introducing cassettes and/or vectors into cells, for affecting the methods of the present invention, such as, but not limited to: direct DNA uptake techniques, and virus, plasmid, linear DNA or liposome mediated transduction, receptor-mediated uptake and magnetoporation methods employing calcium-phosphate mediated and DEAE-dextran mediated methods of introduction, electroporation or liposome-mediated transfection, (for further detail see, for example, “Methods in Enzymology” Vol. 1-3.17, Academic Press, Current Protocols in Molecular Biology, Ausubel F. M. et al. (eds.) Greene Publishing Associates, (1989) and in Molecular Cloning: A Laboratory Manual, 2nd Edition, Sambrook et al. Cold Spring Harbor Laboratory Press, (1989), or other standard laboratory manuals). Bombardment with nucleic acid coated particles is also envisaged. It is to be understood that any of these methods may be utilized for introduction of the desired sequences into cells, and cells thereby produced are to be considered as part of this invention, as is their use for effecting the methods of this invention.

In one embodiment, the vector or gene construct is suitable for in vitro display of an expressed peptide. Preferred in vitro display formats include, ribosome display, mRNA display or covalent display.

In another embodiment, the cassette, vector or gene construct is suitable for expressing a peptide in a cellular host. Preferred cellular hosts in this context are capable of supporting the expression of exogenous or episomal DNA such as, for example, a cellular host, which may be a bacterial cell, yeast cell, insect cell, mammalian cell, plant cell, or others.

In another embodiment, the vector or gene construct is suitable for expressing a peptide in a multicellular organism, and may include multicellular organisms having a compact genome and/or short life cycle to facilitate rapid high throughput screening, such as, for example, a plant (eg., Arabidopsis thaliana or Nicotinia tabaccum) or an animal, such as Caenorhabditis elegans, Danio rerio, Drosophila melanogaster, Takifugu rubripes, or Mus or Rattus genuses.

In another embodiment, the vector or gene construct is suitable for expression in a prokaryote. In another embodiment, the vector or gene construct is suitable for expression in any eukaryotic cell.

### Constructs Encoding Therapeutic Proteins

In one embodiment, the constructs of this invention comprise a gene of interest, which codes for a therapeutic protein.

In one embodiment, the term “construct” refers to an expression cassette, a vector or a library of vectors, as described herein.

In one embodiment, the term “therapeutic”, refers to a molecule, which when provided to a subject in need, provides a beneficial effect. In some cases, the molecule is therapeutic in that it functions to replace an absence or diminished presence of such a molecule in a subject. In one embodiment, the therapeutic protein is that of a protein which is absent in a subject, such as in cases of subjects with an endogenous null or misense mutation of a required protein. In other embodiments, the endogenous protein is mutated, and produces a non-functional protein, compensated for by the provision of the functional protein. In other embodiments, expression of a heterologous protein is additive to low endogenous levels, resulting in cumulative enhanced expression of a given protein. In other embodiments, the molecule stimulates a signalling cascade that provides for expression, or secretion, or others of a critical element for cellular or host functioning.

In one embodiment the therapeutic protein may comprise an enzyme, an enzyme cofactor, a cytotoxic protein, an antibody, a channel protein, a transporter protein, a growth factor, a hormone or a cytokine.

In one embodiment, the term “antibody or antibody fragment” refers to intact antibody molecules as well as functional fragments thereof, such as Fab, F(ab′)2, and Fv that are capable of binding to an epitope. In one embodiment, an Fab fragment refers to the fragment which contains a monovalent antigen-binding fragment of an antibody molecule, which can be produced by digestion of whole antibody with the enzyme papain to yield an intact light chain and a portion of one heavy chain. In one embodiment, Fab′ fragment refers to a part of an antibody molecule that can be obtained by treating whole antibody with pepsin, followed by reduction, to yield an intact light chain and a portion of the heavy chain. Two Fab′ fragments may be obtained per antibody molecule. In one embodiment, (Fab′)₂ refers to a fragment of an antibody that can be obtained by treating whole antibody with the enzyme pepsin without subsequent reduction. In another embodiment, F(ab′)₂ is a dimer of two Fab′ fragments held together by two disulfide bonds. In one embodiment, Fv, may refer to a genetically engineered fragment containing the variable region of the light chain and the variable region of the heavy chain expressed as two chains. In one embodiment, the antibody fragment may be a single chain antibody (“SCA”), a genetically engineered molecule containing the variable region of the light chain and the variable region of the heavy chain, linked by a suitable polypeptide linker as a genetically fused single chain molecule.

Methods of making these fragments are known in the art. (See for example, Harlow and Lane, Antibodies: A Laboratory Manual, Cold Spring Harbor Laboratory, New York, 1988, incorporated herein by reference).

In one embodiment, the antibody will recognize an epitope, which in another embodiment, refers to antigenic determinant on an antigen to which the paratope of an antibody binds. Epitopic determinants may, in other embodiments, consist of chemically active surface groupings of molecules such as amino acids or carbohydrate side chains and in other embodiments, may have specific three dimensional structural characteristics, and/or in other embodiments, have specific charge characteristics.

In one embodiment, the epitope recognized is from a pathogen, or in another embodiment, a pathogenic cell, or in another embodiment, a protein aberrantly expressed, which, in another embodiment, may refer to the location, quantity, or combination thereof of expression.

Antibody fragments according to the present invention can be prepared by proteolytic hydrolysis of the antibody or by expression in E. coli or mammalian cells (e.g. Chinese hamster ovary cell culture or other protein expression systems) of DNA encoding the fragment.

In other embodiments, antibody fragments can be obtained by pepsin or papain digestion of whole antibodies by conventional methods. For example, antibody fragments can be produced by enzymatic cleavage of antibodies with pepsin to provide a 5S fragment denoted F(ab′)2. This fragment can be further cleaved using a thiol reducing agent, and optionally a blocking group for the sulfhydryl groups resulting from cleavage of disulfide linkages, to produce 3.5S Fab′ monovalent fragments. Alternatively, an enzymatic cleavage using pepsin produces two monovalent Fab′ fragments and an Fc fragment directly. These methods are described, for example, by Goldenberg, U.S. Pat. Nos. 4,036,945 and 4,331,647, and references contained therein, which patents are hereby incorporated by reference in their entirety. See also Porter, R. R., Biochem. J., 73: 119-126, 1959. Other methods of cleaving antibodies, such as separation of heavy chains to form monovalent light-heavy chain fragments, further cleavage of fragments, or other enzymatic, chemical, or genetic techniques may also be used, so long as the fragments bind to the antigen that is recognized by the intact antibody.

Fv fragments comprise an association of VH and VL chains. This association may be noncovalent, as described in Inbar et al., Proc. Nat'l Acad. Sci. USA 69:2659-62, 1972. Alternatively, the variable chains can be linked by an intermolecular disulfide bond or cross-linked by chemicals such as glutaraldehyde. Preferably, the Fv fragments comprise VH and VL chains connected by a peptide linker. These single-chain antigen binding proteins (sFv) are prepared by constructing a structural gene comprising DNA sequences encoding the VH and VL domains connected by an oligonucleotide. The structural gene is inserted into an expression vector, which is subsequently introduced into a host cell such as E. coli. The recombinant host cells synthesize a single polypeptide chain with a linker peptide bridging the two V domains. Methods for producing sFvs are described, for example, by Whitlow and Filpula, Methods, 2: 97-105, 1991; Bird et al., Science 242:423-426, 1988; Pack et al., Bio/Technology 11:1271-77, 1993; and Ladner et al., U.S. Pat. No. 4,946,778, which is hereby incorporated by reference in its entirety.

Another form of an antibody fragment is a peptide coding for a single complementarity-determining region (CDR). CDR peptides (“minimal recognition units”) can be obtained by constructing genes encoding the CDR of an antibody of interest. Such genes are prepared, for example, by using the polymerase chain reaction to synthesize the variable region from RNA of antibody-producing cells. See, for example, Larrick and Fry, Methods, 2: 106-10, 1991.

In one embodiment, the antibody is tumoricidal, and is thereby therapeutic in certain cancers. Antibodies that possess tumoricidal activity are also known in the art, the use of any of which may represent an embodiment of this invention, including IMC-C225, EMD 72000, OvaRex Mab B43.13, anti-ganglioside G(D2) antibody ch14.18, C017-1A, trastuzumab, rhuMAb VEGF, sc-321, AF349, BAF349, AF743, BAF743, MAB743, AB1875, Anti-Flt-4AB3127, FLT41-A, rituximab, 2C3, CAMPATH 1H, 2G7, Alpha IR-3, ABX-EGF, MDX-447, anti-p75 IL-2R, anti-p64 IL-2R, and 2A 11.

In another embodiment, the therapeutic protein may comprise an enzyme, such as one involved in glycogen storage or breakdown. In one embodiment, the enzyme is involved in a metabolic pathway. In another embodiment, the invention provides for optimized regulation of production of a compound, which is a function of the regulated expression of a gene of interest. In one embodiment, the compound is a protein, or in another embodiment, a lipid, or in another embodiment, a carbohydrate, or in another embodiment, a mineral, or in another embodiment, a vitamin, or in another embodiment, any compound, whose production may be affected by a gene product of interest, whose expression may be regulated.

In another embodiment, the vector comprises sequences which allow for stable integration of the promoter and the gene of interest in the genome of a cell into which the vector is introduced. According to this aspect of the invention and in one embodiment, use of an integrated system bypasses instability associated with the over-expression of endogenous genes seen at times using plasmid-based systems. However, in another embodiment of this invention, plasmid based systems using the constructs of the present invention are also envisioned.

In one embodiment, growth yield and lycopene production are evaluated using constructs of this invention. In one embodiment, ppc gene regulation, which encodes for phosphoenol pyruvate carboxylase, a key anaplerotic enzyme, is evaluated.

Kinetic control of metabolic pathways is often distributed and dependent on the expression level of several genes within the pathway. Promoter delivery experiments allow for the quantification of this control.

Since optimized regulation of protein expression may be a function of multiple gene products, in one embodiment, this invention provides libraries and methods of use thereof, wherein more than one gene of interest is under the control of the regulatable promoter, as described. In another embodiment, manipulation of other genes of interest may be effected, for use of the constructs of this invention, such as for example, introduction of the vectors described herein in cells genetically disrupted for specific genes involved in a given pathway targeted by the gene of interest. In another embodiment, the vectors are introduced into cells which are genetically engineered to overexpress a particular gene in a given pathway targeted by the gene of interest. In one embodiment, timing of the expression plays a role in terms of the phenotype observed, and may be regulated as a function of the vectors, nucleic acids and/or libraries of this invention.

For example, in one embodiment of this invention, the metabolic pathway studied is that involved in carotenoid production. In one embodiment, such production utilizing the libraries or vectors of this invention, or according to the methods of this invention, may involve the transfer of carotenoid genes into heterologous organisms, resulting in optimal regulation of expression, representing one embodiment of a means of obtaining optimal regulation of production of a compound of interest.

In one embodiment, the compound of interest is produced, as a result of optimal regulation of production of a gene product of interest. For example, carotenoid regulation may be optimized, via the libraries and methods of this invention, via optimizing regulation of a gene product, e.g. an enzyme involved in the processing of the desired product, for example, a carotenoid.

In one embodiment, genes from one organism may be expressed in another for both production, as well as evaluation of maximal production, of a compound of interest, as will be appreciated by one skilled in the art. For example, genes from Erwina uredovora and Haematococcus pluvialis will function together in E. coli (Kajiwara et al. Plant Mol. Biol. 29:343-352 (1995)). E. herbicola genes will function in R. sphaeroides (Hunter et al. J. Bact. 176:3692-3697 (1994)).

In another embodiment of this invention, the libraries or vectors of the present invention may be expressed in bacteria. In one embodiment, bacteria may belong to the Acetobacter, Escherichia, Salmonella, Shigella, Erwina, Haematococcus, Rhodobacter, Myxococcus, Corynebacteria, Pseudomonas, Pyrococcus, Ruminococcus, Mycobacteria, Bacillus genus. In another embodiment, the bacteria may be a methylotroph, or in another embodiment, a methanotroph such as Methylomonas, Methylobacter, Mehtylococcus, Methylosinus, Methylocyctis, Methylomicrobium, Methanomonas, Methylophilus, Methylobacillus, and Methylobacterium.

The term “methylotroph” refers, in one embodiment, to an organism capable of oxidizing organic compounds that do not contain carbon-carbon bonds. Where the methylotroph is able to oxidize methane (CH4), the methylotroph is also a methanotroph. In one embodiment, the methylotroph uses methanol and/or methane as its primary carbon source.

In one embodiment, the methylotrophs and/or methanotrophs are C1 metabolizing bacteria. In one embodiment, the term “C1 metabolizing bacteria” refers to bacteria that have the ability to use a single carbon substrate as their sole source of energy and biomass.

In one embodiment, the term “C1 carbon substrate” refers to any carbon-containing molecule that lacks a carbon-carbon bond. Non-limiting examples are methane, methanol, formaldehyde, formic acid, formate, methylated amines (e.g., mono-, di-, and tri-methyl amine), methylated thiols, and carbon dioxide. In another embodiment, the C1 carbon substrates is selected from the group consisting of methanol and/or methane.

The term “methanotroph” or “methanotrophic bacteria” refers, in another embodiment, to a prokaryote capable of utilizing methane as its primary source of carbon and energy. Complete oxidation of methane to carbon dioxide occurs by aerobic degradation pathways. Typical examples of methanotrophs useful in the present invention include (but are not limited to) the genera Methylomonas, Methylobacter, Methylococcus, and Methylosinus. In one embodiment, the methanotrophic bacteria uses methane and/or methanol as its primary carbon source.

In one embodiment, the term “high growth methanotrophic bacterial strain” refers to a bacterium capable of growth with methane and/or methanol as the sole carbon and energy source and which possesses a functional Embden-Meyerhof carbon flux pathway, resulting in a high rate of growth and yield of cell mass per gram of C1 substrate metabolized (U.S. Pat. No. 6,689,601; hereby incorporated by reference). The specific “high growth methanotrophic bacterial strain” described herein is referred to as “Methylomonas 16a”, “16a” or “Methylomonas sp. 16a”, which terms are used interchangeably and which refer to the Methylomonas strain used in the present invention.

Techniques for the transformation of C1 metabolizing bacteria may parallel the general methodology that is utilized for other bacteria, which is well known to those of skill in the art.

Electroporation has been used successfully for the transformation of: Methylobacterium extorquens AMI (Toyama, H., et al., FEMS Microbiol. Lett., 166:1 7 (1998)), Methylophilus methylotrophus ASI (Kim, C. S., and T. K. Wood, Appl. Microbiol. Biotechnol., 48: 105 108 (1997)), and Methylobacillus sp. strain 12S (Yoshida, T., et al., Biotechnol. Lett., 23: 787 791 (2001)).

Bacterial conjugation, relying on the direct contact of donor and recipient cells, may also be used for the transfer of genes into C1 metabolizing bacteria. Bacterial conjugation processes may involve mixing together “donor” and “recipient” cells in close contact with one another. Conjugation occurs by formation of cytoplasmic connections between donor and recipient bacteria, with direct transfer of newly synthesized donor DNA into the recipient cells. The recipient in a conjugation accepts DNA through horizontal transfer from a donor bacterium. The donor in conjugative transfer may have a conjugative plasmid, conjugative transposon, or mobilizable plasmid.

In some cases, only a donor and recipient are required for conjugation. This occurs when the plasmid to be transferred is a self-transmissible plasmid that is both conjugative and mobilizable (i.e., carrying both tra genes and genes encoding the Mob proteins). In general, the process involves the following steps: 1.) Double-strand plasmid DNA is nicked at a specific site in oriT; 2.) A single-strand DNA is released to the recipient through a pore or pilus structure; 3.) A DNA relaxase enzyme cleaves the double-strand DNA at oriT and binds to a released 5′ end (forming a relaxosome as the intermediate structure); and 4.) Subsequently, a complex of auxiliary proteins assemble at oriT to facilitate the process of DNA transfer.

A “triparental” conjugation may also be required for transfer of the donor plasmid to the recipient. In this type of conjugation, donor cells, recipient cells, and a “helper” plasmid participate. The donor cells carry a mobilizable plasmid or conjugative transposon. Mobilizable vectors contain an oriT, a gene encoding a nickase, and have genes encoding the Mob proteins; however, the Mob proteins alone are not sufficient to achieve the transfer of the genome. Thus, mobilizable plasmids are not able to promote their own transfer unless an appropriate conjugation system is provided by a helper plasmid (located within the donor or within a “helper” cell). The conjugative plasmid is needed for the formation of the mating pair and DNA transfer, since the plasmid encodes proteins for transfer (Tra) that are involved in the formation of the pore or pilus.

Examples of successful conjugations involving C1 metabolizing bacteria include the work of: Stolyar et al. (Mikrobiologiya, 64(5): 686 691 (1995)); Motoyama, H. et al. (Appl. Micro. Biotech., 42(1): 67 72 (1994)); Lloyd, J. S. et al. (Archives of Microbiology, 171(6): 364 370 (1999)); Odom, J. M. et al. (U.S. Ser. No. 09/941947 corresponding to WO 02/18617); U.S. Pat. No. 10/997308; and U.S. Pat. No. 10/997844; hereby incorporated by reference.

In one embodiment, the term “pathway” refers to metabolic pathways, wherein multiple proteins may play regulatory roles, such as, for example, different enzymes whose activity regulates formation of a particular product via, for example, cleavage or hydrogenation, or dehydrogenation, etc., or a precursor, or in another embodiment, of the product to an undesired form, etc.

In another embodiment, the term “pathway” may refer to proteins with somewhat related functions, such that when an overall response is required, the coordinated activity of the two produces a desired result. For example, the gene of interest may be a cytokine, wherein its regulated expression is provided in a host cell with a given HLA type, at a time of administration of a given vaccine, in order to produce maximal immunostimulation, and responsiveness.

In another embodiment, regulated expression of an antigenic protein or peptide is desired to produce a desired immune response. For example, and in one embodiment, low levels of protein/peptide expression may be desired for immunostimulation, while, in another embodiment, high levels of expression of the peptide/protein may be desired for immune tolerance to the protein, to the source from which the peptide is desired, or to a related peptide or protein. In some embodiments, expression of a particular cytokine in such a scenario may be desirable as well, which may bias the response, for example to one less associated with robust autoimmune responses, for example. In one embodiment, in autoimmune diseases, high levels of expression, concurrent with IL-4 expression may be desirable, in order to for example, tolerize the immune response to a given antigen. In another embodiment, high levels of expression of a particular autoimmune peptide or protein may be desired concurrent with expression of an antibody which blocks second signal delivery to a responding T cell, thereby tolerizing the responding T cell.

These are some examples of scenarios where multiple product expression is desired, wherein the ability to regulate the level of expression and/or the timing of expression finds particular application. It is to be understood that any use of regulated expression, as determined using the libraries or via the methods of this invention are to be considered an embodiment of this invention, in any conceivable application or setting.

In another embodiment, the therapeutic protein comprises a transporter, such as an ion transporter, for example CFTR, or a glucose transporter, or other transporters whose deficiency, or inappropriate expression, results in a variety of diseases.

In another embodiment, the therapeutic protein comprises a tumor suppressor, or pro-apoptotic compound, which alters progression of cancer-related events.

In another embodiment, the therapeutic compound of the present invention may comprise an immunomodulating protein. In one embodiment, the immunomodulating protein comprises cytokines, chemokines, complement or components, such as interleukins 1 to 15, interferons alpha, beta or gamma, tumour necrosis factor, granulocyte-macrophage colony stimulating factor (GM-CSF), macrophage colony stimulating factor (M-CSF), granulocyte colony stimulating factor (G-CSF), chemokines such as neutrophil activating protein (NAP), macrophage chemoattractant and activating factor (MCAF), RANTES, macrophage inflammatory peptides MIP-1a and MIP-1b, or complement components.

In another embodiment, a therapeutic compound of this invention may comprise a growth factor, or tissue-promoting factor. In one embodiment, the therapeutic compound is a bone morphogenetic protein, or OP-1, OP-2, BMP-5, BMP-6, BMP-2, BMP-3, BMP-4, BMP-9, DPP, Vg-1, 60A, or Vgr-1. In another embodiment, the therapeutic compound facilitates nerve regeneration or repair, and may include NGF, or other growth factors.

In another embodiment, the therapeutic molecule may be natural or non-natural insulins, amylases, proteases, lipases, kinases, phosphatases, glycosyl transferases, trypsinogen, chymotrypsinogen, carboxypeptidases, hormones, ribonucleases, deoxyribonucleases, triacylglycerol lipase, phospholipase A2, elastases, amylases, blood clotting factors, UDP glucuronyl transferases, ornithine transcarbamoylases, cytochrome p450 enzymes, adenosine deaminases, serum thymic factors, thymic humoral factors, thymopoietins, growth hormones, somatomedins, costimulatory factors, antibodies, colony stimulating factors, erythropoietin, epidermal growth factors, hepatic erythropoietic factors (hepatopoietin), liver-cell growth factors, interleukins, interferons, negative growth factors, fibroblast growth factors, transforming growth factors of the a family, transforming growth factors of the β family, gastrins, secretins, cholecystokinins, somatostatins, serotonins, substance P, transcription factors or combinations thereof.

In another embodiment, this invention provides a plurality of cells comprising the library of expression vectors of this invention.

In one embodiment, each cell comprises a vector of the library, which is stably integrated within the genome of the cell. In one embodiment, the cells do not endogenously express, or have been engineered such that they do not endogenously express the gene of interest.

In another embodiment, the gene is a reporter gene. In one embodiment, the reporter gene encodes a fluorescent protein. In one embodiment, the fluorescent protein is yECitrine or a yellow fluorescent protein. In one embodiment, the fluorescent protein is the jellyfish green fluorescent protein, or a mutant or variant thereof.

In another embodiment, the reporter gene confers drug resistance. In one embodiment, the reporter gene confers resistance to an antibiotic, such as, for example, ampicilin, kanamycin, tetracycline, or others, as will be appreciated by one skilled in the art. In another embodiment, the antibiotic resistance genes may include those conferring resistance to neomycin (neo), blasticidin, spectinomycin, erythromycin, phleomycin, Tn917, gentamycin, and bleomycin. An example of the neomycin resistance gene is the neomycin resistance gene of transposon Tn5 that encodes for neomycin phosphotransferase 11, which confers resistance to various antibiotics, including G418 and kanamycin.

In another embodiment, the reporter is a chloramphenicol acetyl transferase gene (cat) and confers resistance to chloramphenicol.

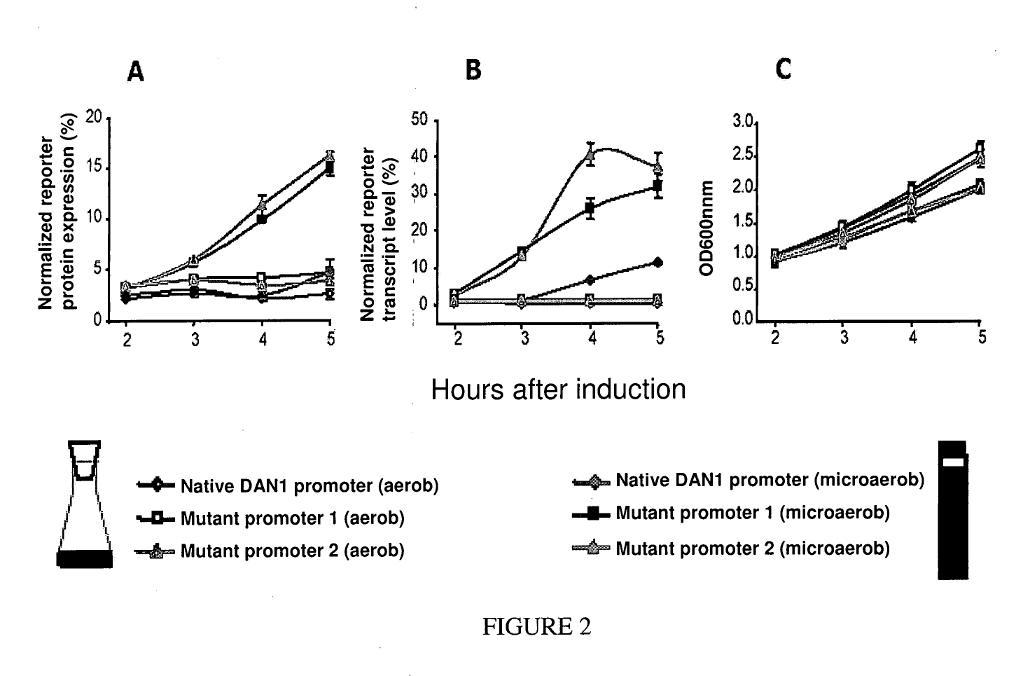

In one embodiment, the performance of the mutant promoter is evaluated by comparison of the expression of the mRNA, protein, or combination thereof, of the reporter gene to the expression of the mRNA, protein, or combination thereof, of the reporter gene comprising a wild-type promoter. In another embodiment, expression levels of the reporter gene under both the wild-type and mutant promoters are compared to expression of the reporter gene under the control of a constitutive promoter. This is exemplified in FIG. 2.

In another embodiment, the selection systems used may include the herpes simplex virus thymidine kinase (Wigler et al., Cell, 11:223 (1977)), hypoxanthine-guanine phosphoribosyltransferase (Szybalska et al., Proc. Natl. Acad. Sci. USA, 48:202 (1992)), and adenine phosphoribosyltransferase (Lowy et al., Cell, 22:817 (1980)) genes employed in tk-, hgprt- or aprt-cells, respectively.

In another embodiment, antimetabolite resistance can be -used by inclusion of the following genes: dhfr, which confers resistance to methotrexate (Wigler et al., Natl. Acad. Sci. USA, 77:357 (1980); O'hare et al., Proc. Natl. Acad. Sci. USA, 78:1527 (1981)); gpt, which confers resistance to mycophenolic acid (Mulligan et al., Proc. Natl. Acad. Sci. USA, 78:2072 (1981)); neo, which confers resistance to the aminoglycoside G418 (Clinical Pharmacy, 12:488-505; WU et al., Biotherapy, 3:87-95 (1991); Tolstoshev, Ann. Rev. Pharmacol. Toxicol., 32:573-596 (1993); Mulligan, Science, 260:926-932 (1993); and Morgan et al., Ann. Rev. Biochem., 62:191-217 (1993); Tibtech 11(5):155-215 (May 1993)); or hygro, which confers resistance to hygromycin (Santerre et al., Gene, 30:147 (1984)).

In another embodiment, the vectors may comprise two or more genes of interest.

Another aspect of the present invention provides a database comprising the nucleotide sequences of nucleic acid fragments of an expression library of the present invention in computer readable form. Such sequences may be used in virtual designs for some of the methods of this invention, in terms of optimizing regulation of production of a protein.

In one embodiment, mutations in a regulatable promoter result in changes in the regulation of the regulatable promoter. In another embodiment, mutations in a regulatable promoter result in optimal regulation of expression of the gene downstream of the regulatable promoter, which in one embodiment, may be an increase in gene expression under conditions that induce expression in the wild-type promoter and no change in gene expression under conditions that do not induce expression from the wild-type promoter. In another embodiment, changes in gene expression as a result of promoter mutations may comprise alterations in the oxygen sensitivity, temperature, pH, nutrient requirements, drug sensitivity, compound sensitivity, which induce gene expression via the promoter. In one embodiment, promoter mutations may increase the amount of the above parameters required for gene expression, while in another embodiment, they may decrease them. In another embodiment, optimal regulation of expression may comprise alterations in tissue characteristics or developmental characteristics that induce gene expression via the promoter. In another embodiment, optimal regulation of expression may comprise alterations in temporal- or spatial-dependent promoter regulation of gene expression.

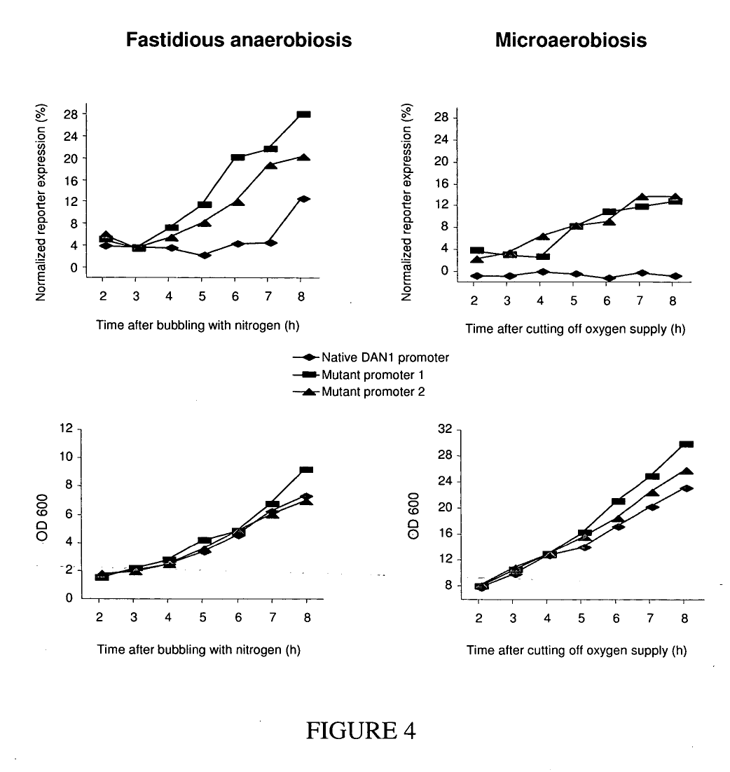

In one embodiment, promoter mutants may increase the expression of a protein under preferred conditions. According to this aspect and in one embodiment, a mutation of a regulatable promoter results in high levels of gene expression under microaerobic conditions. In another embodiment, a mutation results in high levels of gene expression under anaerobic conditions. In one embodiment, microaerobic conditions are conditions in which low levels of oxygen are present. In another embodiment, microaerobic conditions are achieved by preventing oxygen from entering the culture medium, while oxygen that is present is consumed by cells in the incubation medium. In one embodiment, anaerobic conditions are conditions in which oxygen is absent. In another embodiment, anaerobic conditions are achieved by bubbling a culture medium with nitrogen. These two growth conditions are exemplified herein in FIGS. 2 and 4.

In one embodiment, the mutations in each promoter result in varying promoter strength, which, in one embodiment, may vary between 10 and 1000-fold. In one embodiment, methods for optimal regulation of production of a compound of interest, as described herein, may make use of constructs, wherein the gene of interest is expressed at the highest level obtained, or in another embodiment, a construct with less than the maximal yield may be used, which may produce optimal expression, in another embodiment, when the expression of additional genes involved in the production are regulated as well. Such regulation may comprise overexpression, or underexpression, or in another embodiment, inhibiting expression.

In one embodiment, the invention provides a method of optimized gene expression, wherein said gene is under the control of a regulatable promoter, said method comprising:
a. Contacting a plurality of cells with a library of expression vectors, each vector comprising at least one gene of interest and a regulatable promoter operatively linked thereto,
   wherein each promoter comprises a nucleic acid, whose sequence is randomly mutated with respect to that of another in said library, and whereby relative changes in expression level of said gene of interest under conditions, which regulate gene expression, are a function of the mutation in said promoter sequence;
b. Detecting gene expression levels of cells in (a) cultured under said conditions, which regulate gene expression; and
c. Identifying a cell from said plurality of cells in which expression levels under said conditions are optimized.

In another embodiment, the invention provides a method of regulating gene expression, said method comprising:
a. Contacting a plurality of cells with a library of expression vectors, each vector comprising at least one gene of interest and a regulatable promoter operatively linked thereto,
   i. wherein each promoter comprises a nucleic acid, whose sequence is randomly mutated with respect to that of another in said library, and
   ii. whereby changes in an expression level of said gene, expression conditions of said gene of interest, or a combination thereof, of said gene of interest occur under regulatable conditions as a function of said mutation;
b. Detecting gene expression in said plurality of cells obtained in (a), under conditions where wild-type gene expression occurs sub-optimally;
c. Identifying a cell from said plurality of cells in which greater expression levels are obtained from said vectors, under conditions where wild-type gene expression occurs sub-optimally; and
d. Culturing said cell identified in (c) under said conditions.

In one embodiment, the methods may make use of the vectors of this invention, comprising any embodiment as described herein, or any combination thereof, including, in other embodiments, comprising sequences which allow for stable integration of the promoter and the gene of interest in the genomes of the cells, where optimized regulation of production is to be determined.

In another embodiment, each vector in the library provides a consistent level of expression of the gene of interest, which, in another embodiment, is verified via at least two different methods. In one embodiment, the method or methods of the present invention detect protein expression levels using a fluorescence spectrometer. In another embodiment, the method or methods detect MRNA expression levels of the reporter gene using quantitative RT-PCR. In another embodiment, the method or methods verify expression at a single cell level, and in another embodiment, may comprise fluorescent activated cell sorting analysis, fluorescence microscopy, or a combination thereof. In another embodiment, the detection of relative changes in expression is accomplished with the use of quantitative polymerase chain reaction. In another embodiment, the detection of relative changes in expression in the case where the at least one gene of interest encodes an enzyme is accomplished via determining the enzyme activity.

Embodiments of the methods are provided, for example, in FIG. 2, where fluorescent activated cell sorting analysis was used to measure reporter protein expression and quantitative RT-PCR was used to measure reporter transcript levels.

In one embodiment, increased gene expression may be evaluated compared to expression under the wild-type promoter, while in another embodiment, it may be evaluated compared to expression under a constitutive promoter. In one embodiment, cells comprising the mutated promoters may have increased expression of a gene of interest when grown in large volume. FIG. 4 exemplifies this embodiment. DAN1 promoter mutants that had increased levels of protein expression compared to wild-types when grown in microaerobic conditions exemplified in FIG. 2, also had increased levels of protein expression compared to wild-types when grown in large volume in both microaerobic and anaerobic conditions.

In another embodiment, optimized regulation of production of a compound of interest is evaluated, wherein the production of the compound is a function of the regulated expression of a gene of interest, or, in another embodiment, two or more genes of interest. In one embodiment, according to this aspect of the invention, the method may be conducted similarly to that set forth for determination of optimized gene expression of a gene of interest.

In one embodiment, the methods of this invention, when evaluating optimized regulation of production of a compound, which comprise vectors with two or more genes encoding proteins of interest, involve genes encoding proteins which are interrelated. In one embodiment, the two or more genes encode proteins involved in a metabolic pathway, or as described hereinabove, the two or more genes are interrelated in terms of their concerted effects on a particular pathway, as described and/or defined herein. In one embodiment, such genes may be overexpressed.

In another embodiment, this invention provides a cell with a desired expression level of a gene of interest, identified by a method of this invention. In another embodiment, the cells according to the methods of this invention, do not endogenously express, or have been engineered such that they do not endogenously express the gene or genes of interest. In another embodiment, the vectors comprise sequences which allow for stable integration of the promoter and the gene of interest in the genomes of the cells.

In another embodiment, the method further comprises identifying the promoter within the cell. According to this aspect and in one embodiment, the promoter is identified by sequence analysis. In another embodiment, this invention provides a method of optimized regulation of protein delivery to a subject, comprising administering to a subject a vector comprising the promoter identified herein.

In another embodiment, this invention provides a method of optimized regulation of protein delivery to a subject, comprising administering to said subject a cell which has an optimized regulation of the protein, identified via a method of this invention.

In one embodiment, determination of homogeneous expression is accomplished via the use of two separate methods, which quantify expression.

In one embodiment, the libraries and methods of this invention constitute an integral platform for functional genomics and metabolic engineering.

In another embodiment, this invention provides a method of optimized regulation of protein delivery to a subject, the method comprising administering to the subject a vector comprising a promoter identified via the methods of this invention. As described herein, and in one embodiment, this invention provides a means for determining optimized regulation of production of a compound, using the libraries of this invention. Once such optimized regulation of production is determined, the constructs which impart the optimized regulation of production may then be administered to a subject. In one embodiment, such optimized regulation of production may be accomplished in a cell or plurality of cells, which may, in -another embodiment, be administered to a subject. In one embodiment, the construct may be delivered to a subject. In one embodiment, delivery of the cell or construct to a subject may be a means of cell or gene therapy, respectively, as will be understood to one skilled in the art.

In one embodiment, the cell with optimized regulation of expression, or contacted with a vector for optimized regulation of expression, etc., of this invention, does not endogenously express, or has been engineered such that it does not endogenously express the gene of interest. In one embodiment, such a cell may be engineered to express or overexpress a second gene of interest, or, in another embodiment, a variant or mutant of the first gene of interest, or in another embodiment, may express the gene of interest under the control of a promoter, identified in this invention, as providing a desired expression level of a gene or genes of interest, as described herein.

In another embodiment, such cells may be prokaryotic or eukaryotic, and may be expanded in culture. In one embodiment, such cells may be ex-vivo expanded, then reimplanted in a host, wherein the cells are modified in culture, prior to their implantation. In one embodiment, the cell may be a stem cell, or in another embodiment, a progenitor cell, or in another embodiment, a differentiated cell. In one embodiment, the cells which are to be implanted in a subject may be further engineered to comprise a protein which facilitates the homing of the cell to a desired location. Such proteins are recognized by one skilled in the art, and may comprise specific adhesion molecules, integrins, etc., which enable specific delivery to a site of interest. In another embodiment, specific delivery to a site may be accomplished via the means of delivery, such as, for example, direct injection to a site of interest, or, for example, delivery via route of administration to a desired site via particular formulation, such as, for example, aerosol formulation for lung delivery, or for example, formulation in a suppository for delivery to particular mucosal sites, or for example, topical formulation for delivery to a skin, etc.

In one embodiment, the gene of interest is a reporter gene, which in one embodiment is a fluorescent or luminescent protein.

In one embodiment, the method or methods of the present invention further comprise identifying the promoter within the identified cell.

In one embodiment, this invention provides a cell with an optimized regulation of expression of a protein of interest under conditions that sub-optimally induce wild-type gene expression, identified by one or more of the methods of this invention.

In one embodiment, this invention provides a method of optimized regulation of production of a protein of interest under conditions that sub-optimally induce wild-type gene expression, said method comprising growing a cell of this invention under conditions that sub-optimally induce wild-type gene expression. In one embodiment, the cell is eukaryotic, while in another embodiment, it's prokaryotic.

In another embodiment, this invention provides a method of optimized regulation of protein delivery to a subject under conditions that sub-optimally induce wild-type gene expression, the method comprising administering to said subject a cell of this invention, whereby said cell expresses an optimized regulation of said protein under conditions that sub-optimally induce wild-type gene expression. In one embodiment, the cell is a stem cell.

It is to be understood that any delivery means for provision of the constructs, or cells of this invention, and/or to effect the methods of this invention, are to be considered as part of the invention.

The following are meant to provide materials, methods, and examples for illustrative purposes as a means of practicing/executing the present invention, and are not intended to be limiting.

### EXAMPLES

### Materials And Experimental Methods

Plasmid Construction, Strains And Cultivation Conditions, And Reagents

The DAN1 promoter (region from -551 to -1 upstream of DAN1 coding sequence) was amplified via PCR using genomic DNA from S. cerevisiae BY4741 as a template along with the primers GTTAAAAATTGTTGAGCTCAATTC (SEQ ID NO: 12) and CGAGTTCTAGATACTTGGGGTATATATTTAGTATG (SEQ ID NO: 13). The resulting PCR product of 563 bp in length was cut with SacI and XbaI and cloned into the SacI/XbaI restricted vector p416-TEF-yECitrine, thereby replacing the TEF1 promoter upstream of yECitrine with the DAN1 promoter. The resulting plasmid was named p416-DAN-yECitrine.

The plasmid p416-TEF-yECitrine was obtained by cloning the coding sequence of yECitrine, a yeast codon optimized version of the yellow fluorescent protein (Sheff & Thorn Yeast 21, 661-670 (2004)) downstream of the TEF1 promoter). The coding sequence of yECitrine which was used as a reporter protein in this study was amplified via PCR from the plasmid pKT140 obtained from EUROSCARF using the primer CGAGTTCTAGAAAAATGTCTAAAGGTGAAGAATTATTC (SEQ ID NO: 14) and TAGCGATCGATTTATTTGTACAATTCATCCATACC (SEQ ID NO: 15). The PCR product was cut with ClaI and XbaI and ligated to ClaI/XbaI restricted vector p416-TEF (Mumberg et al. Gene 156, 119-122 (1995)) obtained from ATCC.

S. cerevisiae strain BY4741 (MATa; his3Δ1; leu2Δ0; met15Δ0; ura3Δ0) used in this study was obtained from EUROSCARF, Frankfurt, Germany. It was cultivated in YPD medium (10 g of yeast extract/liter, 20 g of Bacto Peptone/liter and 20 g glucose/liter). For yeast transformation, the Frozen-EZ Yeast Transformation II (ZYMO RESEARCH) was used. To select and grow yeast transformants bearing plasmids with URA3 as selectable marker, a yeast synthetic complete (YSC) medium was used containing 6.7 g of Yeast Nitrogen Base/liter (Difco), 20 g glucose/liter and a mixture of appropriate nucleotides and amino acids (CSM-URA, Qbiogene) referred here as to YSC Ura-. Medium was supplemented with 1.5% agar for solid media. Yeast cells were routinely cultivated at 30° C. in Erlenmeyer flasks shaken at 200 rpm. For FACS sorting of single cells (DAN1 promoter mutations) into microtiter plates, each well contained 200 μL YSC Ura- supplemented with 10 mg/L ergosterol, 420 mg/L Tween 80 (Nelms, J. et al., Appl Environ Microbiol 58, 2592-2598 (1992)).

Microaerobic conditions in laboratory scale were achieved by pouring the cultures into screw capped vials up to the top and incubation without agitation at 30° C. Anaerobiosis was obtained by bubbling the cultures with high purity (99.8%) nitrogen for 2 min. Media used for microaerobic or anaerobic cultivation were also supplemented with 10 mg/L ergosterol and 420 mg/L Tween 80.

E. coli DH5a (Invitrogen) used for routine transformations were cultured at 37° C. in LB medium and 100 μg/mL ampicillin as necessary. Cell density was monitored spectrophotometrically at 600 nm. All PCR reagents and restriction enzymes were purchased from New England Biolabs (Ipswich Mass.). All remaining chemicals were from Sigma-Aldrich (St. Louis Mo.).

Library Construction

Nucleotide analogue mutagenesis was carried out in the presence of 20 μM 8-oxo-2′-deoxyguanosine (8 oxo-dGTP) and 6-(2-deoxy-β-D-ribofuranosyl)-3,4-dihydro-8H-pyrimido-[4,5-c] [1,2]oxazin-7-one (dPTP) (Zaccolo. & Gherardi J Mol Biol 285, 775-783 (1999)). Using plasmid p416-DAN-yECitrine as template along with the primers ATTGGGACAACACCAGTGAATAATTCTTCACCTTTAGACATTTTTCT (SEQ ID No: 16) and ACGCCAAGCGCGCAATTAACCCTCACTAAAGGGAACAAAAGCTGGAGC (SEQ ID No: 17), 10, 20 and 30 amplification cycles with the primers mentioned above were performed. The PCR products were purified using the GeneClean Spin Kit (Qbiogene, Morgan Irvine Calif.). The mix of mutagenized PCR products was transformed into yeast via recombinatorial cloning (Raymond et al. Biotechniques 26, 134-138, 140-131 (1999)) together with p416-TEF-yECitrine which had been previously cut with SacI/XbaI.

Fluorescence Measurements, Flow Cytometry, And Cell Sorting

Measurement of specific fluorescence was performed using cells harvested from the logarithmic phase during growth in shake flasks (20 mL medium in 250 mL Erlenmeyer flasks). Fluorescence of yECitrine was measured in diluted cultures (OD 600 between 0.1 and 0.3) in fluorescence cuvettes using a fluorescence spectrometer (HITACHI F-2500) with an excitation wavelength of 502 nm and an emission wavelength of 532 nm. The specific fluorescence refers to the ratio of fluorescence level and the OD 600 measured in the same cuvette. For flow cytometry and FACS, cells from the exponential growth phase (OD 1.0-1.5) were centrifuged at 600g for 2 min, resuspended in sterile distilled water and put on ice until measurement. Flow cytometry was performed on a Becton-Dickinson FACScan instrument using CellQuest software. Single cells were sorted into microtiter plates using a Becton Dickinson FACS Aria high speed cell sorter with Diva software.

Because formation of mature yECitrine requires oxygen, all samples taken from microaerobic or anaerobic cultures were incubated in a shake flask for 45 min at 30° C. before fluorescence was measured.

RNA Quantification

Total yeast RNA was extracted using the RiboPure™M-Yeast Kit (AMBION) including DNAse treatment. RNA concentration was quantified by absorbance at 260 nm. Quantification of yECitrine MRNA was performed using the iScipt One-Step RT-PCR Kit with SYBR Green and an iCycler thermocycler (Bio-Rad). We used 100 ng total yeast RNA per RT-PCR reaction. Primers ATGGCTGACAAACAAAAGAATG (SEQ ID No: 18) and CAGATTGATAGGATAAGTAATG (SEQ ID No: 19) were used in RT-PCR. Data were analyzed using the iCycler software (Bio-Rad Laboratories, Hercules Calif.).

Fermentations

The synthetic medium used in fermenter experiments contained 100 g/L sucrose, 24 g/L sodium glutamate, 10 g/L NZ amines, 10 g/L ammonium sulfate, 6.4 g/L ammonium dihydrogen phosphate, 3 g/L potassium chloride, magnesium sulfate 1.5 g/L, 0.2 g/L calcium chloride, 0.2 g/L myo-inositol, Ig/L leucine, 1 g/L histidine, 1 g/L methionine, 8 mg/IL D-pantothenic acid, 8 mg/L pyridoxine, 8 mg/L thiamine, 8 mg/L nicotinic acid, 46 μg/L biotin, 0.03 g/L zinc sulfate, 0.03 g/L manganese sulfate, 5 mg/L sodium molybdenum oxide, 8 mg/L copper sulfate, 12.5 mg/L ferric sulfate.

Fermenter experiments were carried out at 30° C. in a 3.2 liter BIOSTAT-E fermenter (Braun, Germany) with a working volume of 2 L. The culture pH was kept at pH 5.0 by automatic addition of 4M H₂SO₄ or 4M KOH. Cultures were stirred at 600 rpm and sparged with air at 1 vvm until oxygen sparging was either switched off for microaerobic conditions or replaced by nitrogen sparging (1 vvm) for 5 min to obtain anaerobiosis. Development of foam was prevented by the addition of polyethylene glycol 2000 (60% w/v). Dissolved oxygen was monitored with an autoclavable oxygen electrode (Ingold, Switzerland). Sucrose analysis was performed with a kit from r-Biopharm kit (Darmstadt, Germany).

Promoter Sequencing

Promoters were sequenced using primers ATTGGGACAACACCAGTGAATAATTCTTCACCTTTAGACATTTTTCT (SEQ ID No: 16) and ACGCCAAGCGCGCAATTAACCCTCACTAAAGGGAACAAAAGCTGGAGC (SEQ ID No: 17).

### Example 1

### Mutation of DAN1 Promoter

Error-prone PCR technology (Zaccolo & Gherardi J Mol Biol 285, 775-783 (1999)) was used to mutate the 551 bp region of the DAN1 promoter immediately upstream of the promoter start (FIG. 1A). After PCR, the mean mutation rate was estimated to be 11.2 mutations per every 551 nt. The library of mutant promoters was cloned upstream of a yECitrine fluorescent reporter protein optimized for expression in S. cerevisiae (Sheff & Thorn Yeast 21, 661-670 (2004)). Approximately 12,000 transformants of the yeast strain BY4741 were obtained using the method of recombinational cloning.

### Example 2

### Fluorescent Reporter Protein Production In DAN1 And Mutant Libraries

Fluorescence histograms of the mutant library and the control strain (unmutated DAN1 promoter) grown under varying conditions of oxygen availability are shown in FIG. 1B. Shake flasks were used to provide aerobic conditions and fastidious anaerobiosis was obtained by bubbling the culture with pure nitrogen. To obtain microaerobiosis, the culture was grown in closed, air-tight vials. Because residual dissolved oxygen is consumed during cell growth, these conditions sharply lower, but do not completely deplete, oxygen availability during the course of the cell growth. Full induction of the unmutated DAN1 promoter was only obtained under fastidious anaerobiosis.

The fluorescence histogram of the mutant library under fastidious anaerobiosis (FIG. 1B) showed that approximately 20% of the library was induced to some extent, which is indicative of the wide-spread conservation of essential DAN1 features among library members. The fluorescence histogram of microaerobically cultured library cells appears visually similar to the non-induced aerobic library, but the two distributions are statistically different (X² test with 983 d.o.f., p<10⁻⁹), indicating that there is partial library induction even under microaerobic conditions.

### Example 3

### Fluorescence Associated Cell Sorting

The promoter mutant library was subjected to multiple rounds of fluorescence associated cell sorting (FACS). For the first round, which was designed to remove all promoter mutants no longer repressed by oxygen, cells were pre-grown under aerobic conditions and sorted by FACS using the cutoff shown in FIG. 1B to eliminate mutants showing high fluorescence (i.e. promoter activation under aerobic conditions). The sub-library isolated in this way contained 87% of the clones in the original library. For the second round of FACS, cells of the sub-library were subjected to microaerobic conditions for 4 hours. Despite the fact that the vast majority of library clones were less fluorescent under fastidious anaerobiosis than the wild-type DAN1 promoter, we screened our sub-library for mutants at the extreme high end of the fluorescence distribution, as shown in FIG. 1B. This stringent cutoff resulted in the elimination of 99.98% of the library members.

### Example 4

### Characterization of Selected Clones In Monoclonal Cultures

Ten clones were isolated from the remaining 0.02% of the library and characterized in monoclonal cultures. Before retransformation, nine of the ten clones showed 1.4- to 3.5-fold elevated fluorescence induction compared to the wild-type DAN1 promoter. After retransformation of plasmids, six of the ten clones showed a 1.8- to 2.9-fold higher fluorescence than wild-type DAN1 promoter after 4 hours of microaerobiosis (data not shown). The remaining four clones showed statistically similar induction levels to the wild-type promoter (data not shown).

### Example 5

### Characterization of Selected Clones—Induction Dynamics

We measured the induction dynamics of two of the mutant clones by fluorescence measurements and by quantitative RT-PCR (FIG. 2). Following transition from aerobic to microaerobic culture conditions, the levels of both the yECitrine mRNA transcript and the yECitrine protein (as measured by fluorescence) increased over a five hour period. Transcript levels in the two mutants showed a noticeable increase after 3 hours and saturation at at least 25-fold (mutant 1) to 38-fold (mutant 2) the uninduced level after 5 hours.

However, it is likely that true fold increase may-be much higher, since our estimate of the uninduced mRNA concentration is near the basal noise level of our RT-PCR protocol. For better comparison, we therefore normalized all data to levels obtained with a constitutive reference promoter (TEF1 promoter (Huet, J. et al. Embo J 4, 3539-3547 (1985)). The induction of the mutant promoters after 5 hours corresponded to a relative value of about 30-40% of the transcript level driven by the TEF1 promoter (FIG. 2B). The yECitrine mRNA transcript level in the wild-type DAN1 culture, on the other hand, did not increase until 4 hours after induction, and the level after 5 hours was only 10% of the mutant strains. Protein levels closely followed mRNA levels, with 3.8- and 4.5-fold induction of fluorescence in the two mutants after 5 hours of induction, which corresponds to about 15% of the TEF1 promoter driven expression (FIG. 2A). The slight increase in mRNA observed in the wild-type sample only barely propagated to the protein level (a 1.9-fold increase to 5% of the TEF1 promoter strength). The lag between the fluorescence time profile relative to the mRNA time profile is likely to be due to the oxygen-dependent maturation of yECitrine.

### Example 6

### Characterization of Selected Clones—Sequence Analysis

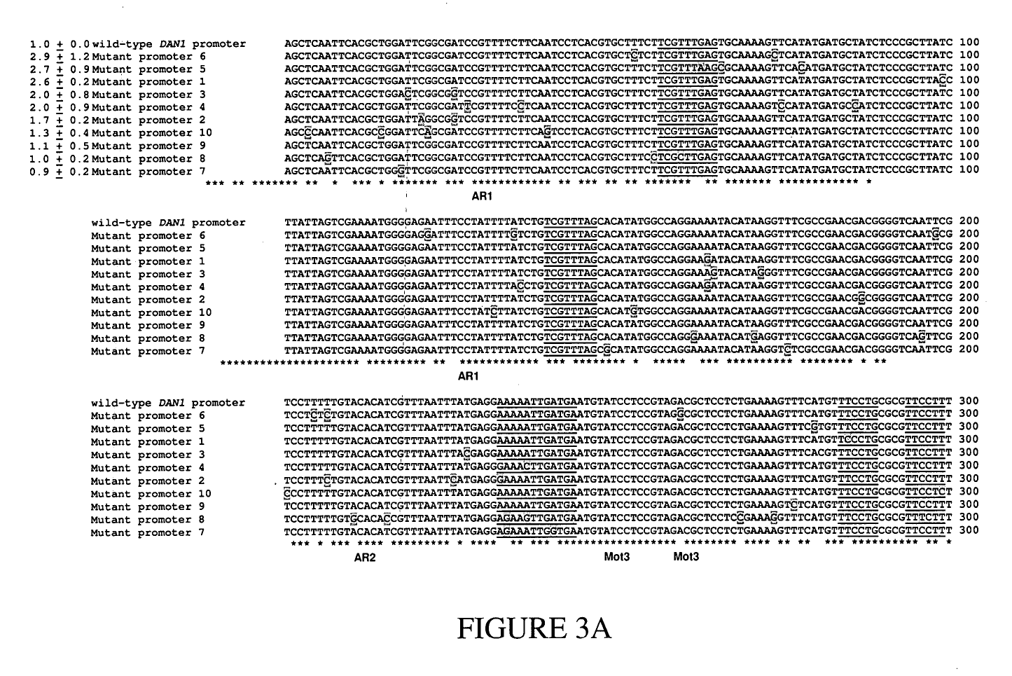

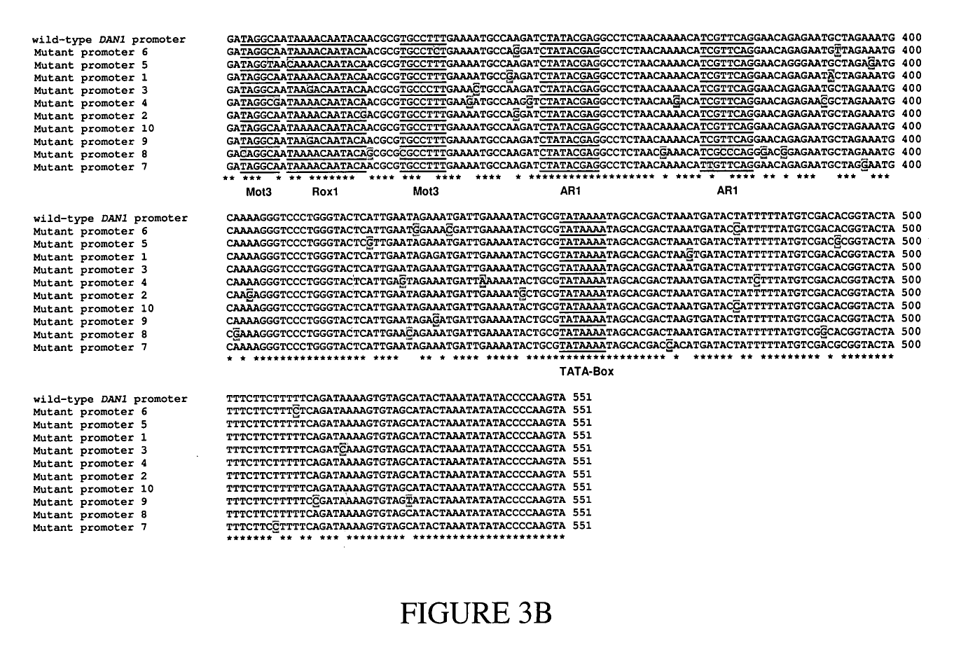

Sequence analysis of the ten isolated mutants (Table 1) revealed several mutations in the known transcription factor binding sites for the DAN1 promoter (FIG. 3). However, there were also many mutations outside of known transcription factor binding sites and outside of the TATA box (FIG. 3). There is no obvious concentration of mutations in the known transcription factor binding sites, indicating that other transcription factors may be involved in the oxygen-dependent gene expression from this promoter.

TABLE 1
Sequences of wild type DAN1 promoter and ten isolated mutants
created using error-prone PCR.

| Pro- | | |
|---|---|---|
| moter | | SEQ |
| Num- | | ID |
| ber | Promoter Sequence | No: |
| Wild- type DAN1 pro- moter | 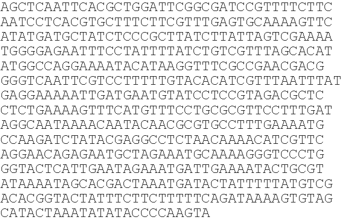 | 11 |
| Mu- tant Pro- moter 1 | 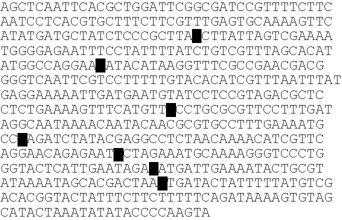 | 1 |
| Mu- tant Pro- moter 2 | 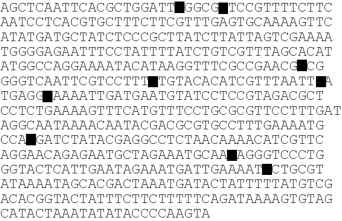 | 2 |
| Mu- tant Pro- moter 3 | 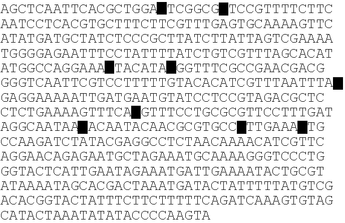 | 3 |
| Mu- tant Pro- moter 4 | 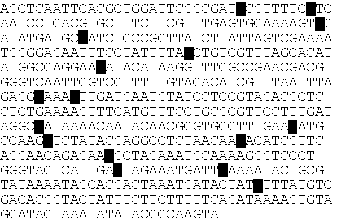 | 4 |
| Mu- tant Pro- moter 5 | 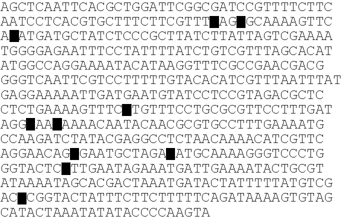 | 5 |
| Mu- tant Pro- moter 6 | 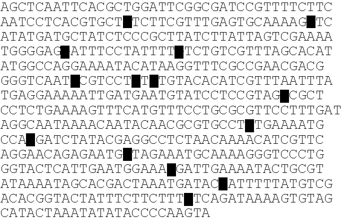 | 6 |
| Mu- tant Pro- moter 7 | 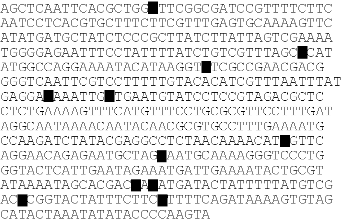 | 7 |
| Mu- tant Pro- moter 8 | 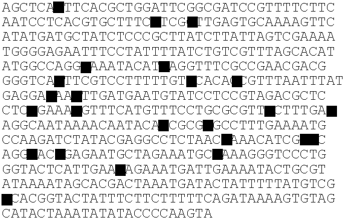 | 8 |
| Mu- tant Pro- moter 9 | 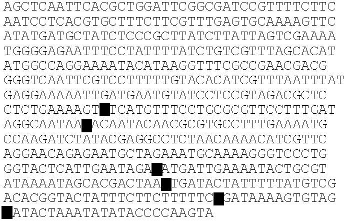 | 9 |
| Mu- tant Pro- moter 10 | 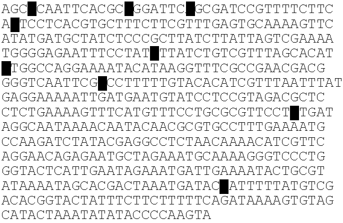 | 10 |

Highlighted sequences indicate mutations compared to wild-type.

### Example 7

### Characterization of Selected Clones—Batch Yeast Fermentation

The performance of the isolated clones was tested in batch 2-L yeast fermentations using two different conditions for oxygen depletion (FIG. 4). In one condition for oxygen depletion, cultures at a turbidity of A₆₀₀=2 were bubbled with nitrogen to obtain fastidious anaerobiosis. In the second condition for oxygen depletion, higher density batch fermentations (initial A₆₀₀=8) were subjected to microaerobiosis (obtained by cutting the aeration supply). Cells harboring mutant promoters produced higher levels of reporter expression and more quickly than the wild-type DAN1 promoter under both conditions tested. Dissolved oxygen concentrations dropped to undetectable levels immediately after bubbling with nitrogen or cutting off the oxygen supply, respectively (data not shown). Low-density microaerobic fermentation did not lead to detectable induction (data not shown). In the low-density fermentations, the time required for dissolved oxygen depletion was significantly longer, suggesting that dissolved oxygen concentration in these cultures at the end of 8 hours was still too high to effect induction.

The Examples hereinabove provide a general framework for the optimization of the regulation of a promoter's response to its regulator to control gene expression under particular conditions in vivo. Even though the biology of regulated gene expression is complex, occurring via a complex network of interactions with multiple transcription factors and metabolic and regulatory pathways for heme biosynthesis and degradation, sequence changes at the promoter level can be used to engineer gene regulation properties in user-specified ways. Using the oxygen-regulated DAN1 promoter of S. cerevisiae, it was demonstrated that the concept of promoter engineering combined with a suitable selection strategy can be used to optimize the regulatory properties of a promoter. The strategy to optimize the response of a promoter to its regulator is generalizable to many other promoters and regulators, and is extendable to other organisms. Hence, it represents a valuable tool for improving existing promoters and for creating new ones. Possible applications include industrial processes and biomedical research where there is a demand for specific cell, tissue and drug dependent promoters.

What is claimed is:

1. An isolated nucleic acid comprising a mutated DAN1 promoter corresponding to or homologous to SEQ ID No: 1, 2, 3, 4, 5, 6, 7, 8, 9, or 10.

2. An isolated nucleic acid comprising a mutated DAN1 promoter corresponding to or homologous to SEQ ID No: 1, 2, 3, 4, 5, or 6.

3. An isolated nucleic acid comprising a mutated DAN1 promoter corresponding to or homologous to SEQ ID No: 1 or 2.

4. A vector comprising the isolated nucleic acid of claim 1.

5. An isolated nucleic acid comprising a mutated DAN1 promoter, wherein said promoter comprises a mutation in at least one nucleic acid at one or more of the following positions of SEQ ID No: 11:
a) 1-56
b) 66-139
c) 148-232
d) 245-283
e) 290-293
f) 301-302
g) 310
h) 322-326
i) 334-347
j) 357-371
k) 380-450 or
l) 458-551.

6. The nucleic acid of claim 5, wherein said mutation is at position: 4, 7, 15, 18, 19, 21, 22, 26, 28, 36, 40, 53, 56, 60, 63, 66, 74, 75, 78, 86, 99, 122, 132, 135, 136, 149, 153, 162, 164, 165, 171, 172, 176, 187, 196, 198, 201, 205, 207, 211, 216, 226, 228, 233, 234, 237, 241, 260, 269, 274, 277, 280, 281, 285, 296, 299, 303, 307, 308, 310, 313, 322, 327, 331, 332, 337, 338, 343, 344, 346, 366, 368, 373, 375, 376, 381, 384, 386, 390, 391, 392, 396, 397, 402, 404, 422, 427, 428, 429, 432, 434, 439, 445, 467, 469, 470, 477, 480, 490, 492, 508, 511, 514, 518, 528, or a combination thereof.

7. A vector comprising the isolated nucleic acid of claim 5.

8. An isolated nucleic acid comprising a mutated DAN1 promoter, wherein said mutated promoter has a sequence comprising a replacement of:
a) a T with a C at nucleotide position 4, 15, 19, 36, 53, 56, 60, 66, 74, 75, 78, 86, 99, 132, 136, 176, 201, 205, 207, 216, 226, 228, 269, 277, 281, 285, 299, 303, 310, 327, 331, 332, 375, 376, 390, 428, 434, 467, 477, 480, 508, or 511;
b) an A with a G at at nucleotide position 7, 18, 26, 40, 122, 135, 149, 153, 162, 164, 165, 171, 172, 187, 196, 211, 233, 234, 237, 241, 260, 274, 280, 308, 313, 322, 337, 343, 344, 346, 366, 368, 381, 384, 386, 396, 397, 402, 404, 422, 427, 429, 432, 445, 470, 490, or 492;
c) a C with an A at nucleotide position 21;
d) an A with a C at nucleotide position 237, 338, 469, 514, 518;
e) a C with a T at nucleotide position 28, 296, 307, 373, 392, or 528;
f) a G with an A at nucleotide position 22, 63, 391, or 439;
g) a T with a G at nucleotide 198;
or any combination thereof, of the sequence as set forth in SEQ ID NO: 11.

9. A vector comprising the isolated nucleic acid of claim 8.

10. A library of expression vectors, comprising a vector of claim 4, 7, 9 or a combination thereof.

11. A method of determining optimized gene expression, wherein said gene is under the control of a regulatable promoter, said method comprising:
a) Contacting a plurality of cells with a library of expression vectors, each vector comprising at least one gene of interest and a regulatable promoter operatively linked thereto,
wherein each promoter comprises a nucleic acid, whose sequence is randomly mutated with respect to that of another in said library, and
whereby relative changes in expression level of said gene of interest under conditions, which regulate gene expression, are a function of the mutation in said promoter sequence;
b) Detecting gene expression levels of.cells in (a) cultured under said conditions, which regulate gene expression; and
c) Identifying a cell from said plurality of cells in which expression levels under said conditions are optimized.

12. The method of claim 11, wherein said gene is a reporter gene.

13. The method of claim 12, wherein said reporter gene encodes a fluorescent or luminescent protein.

14. The method of claim 11, wherein said detecting is accomplished with the use of a fluorescence spectrometer.

15. The method of claim 11, wherein said detecting is accomplished with the use of quantitative polymerase chain reaction.

16. The method of claim 11, wherein said cells are eukaryotes.

17. The method of claim 16, wherein said cells are yeast cells.

18. The method of claim 16, wherein said cells are mammalian cells.

19. The method of claim 11, wherein each vector in said library provides a consistent level of expression of said gene of interest.

20. The method of claim 19, wherein said consistent level of expression is verified via at least two different methods.

21. The method of claim 20, wherein one of said at least two different methods verifies expression at a single cell level.

22. The method of claim 20, wherein said methods comprise fluorescent activated cell sorting analysis, fluorescence microscopy, or a combination thereof.

23. The method of claim 11, further comprising the step of comparing expression levels to that obtained from wild-type cells.

24. The method of claim 11, further comprising identifying the promoter within said cell.

25. A method of optimized regulation of delivery of a protein of interest to a subject, the method comprising administering to said subject a vector comprising the promoter identified in claim 24 operatively linked to a gene encoding said protein of interest.

26. A cell with an optimized regulation of expression of a regulatable gene of interest, identified by the method of claim 11.

27. The cell of claim 26, wherein said cell is eukaryotic.

28. The cell of claim 27, wherein said cell is administered to a subject.

29. The cell of claim 27, wherein said cell is a stem cell.

30. A method of optimized regulation of protein delivery to a subject, the method comprising administering to said subject a cell of claim 26, whereby said cell expresses an optimized regulation of said protein.

31. A method of regulating gene expression, said method comprising:
a) Contacting a plurality of cells with a library of expression vectors, each vector comprising at least one gene of interest and a regulatable promoter operatively linked thereto,
i) wherein each promoter comprises a nucleic acid, whose sequence is randomly mutated with respect to that of another in said library, and
ii) whereby changes in an expression level of said gene, expression conditions of said gene of interest, or a combination thereof, of said gene of interest occur under regulatable conditions as a function of said mutation;
b) Detecting gene expression in said plurality of cells obtained in (i), under conditions where wild-type gene expression occurs sub-optimally;
c) Identifying a cell from said plurality of cells in which greater expression levels are obtained from said vectors, under conditions
where wild-type gene expression occurs sub-optimally; and
d) Culturing said cell identified in (c) under said conditions.

32. The method of claim 31, wherein said gene is a reporter gene.

33. The method of claim 32, wherein said reporter gene encodes a fluorescent or luminescent protein.

34. The method of claim 31, wherein each vector in said library provides a consistent level of expression of said gene of interest.

35. The method of claim 34, wherein said consistent level of expression is verified via at least two different methods.

36. The method of claim 35, wherein one of said at least two different methods verifies expression at a single cell level.

37. A cell obtained via the method of claim 31, step (d).

38. A method of optimizing protein production, the method comprising culturing said cell of claim 37.

39. The method of claim 38, wherein said cell is eukaryotic.

40. The method of claim 38, wherein said cell is prokaryotic.

41. The method of claim 38, wherein said protein or said cell is administered to a subject.

42. The method of claim 41, wherein said cell is a stem cell.
